(19) United States
(12) Patent Application Publication
(10) Pub. No.: US 2023/0260192 A1
(43) Pub. Date: Aug. 17, 2023

(54) INTERACTIVE SITE ANALYSIS REPORT GENERATION

(71) Applicant: Avi Malka, Ashkelon (IL)

(72) Inventor: Avi Malka, Ashkelon (IL)

(21) Appl. No.: 18/052,997

(22) Filed: Nov. 7, 2022

Related U.S. Application Data
(60) Provisional application No. 63/276,061, filed on Nov. 5, 2021.

(51) Int. Cl. G06T 15/00; G06V 10/25; G06F 3/04842

(52) U.S. Cl. CPC G06T 15/00; G06F 3/04842; G06V 10/25

(57) ABSTRACT

A computer-implemented method of generating interactive site reports, the method comprising acquiring data associated with a specific site; generating three-dimensional images of the site; generating markings to enable a user to access detailed information regarding the site; and displaying the information on a computing device.

### RELATED APPLICATION/S

This application claims the benefit of priority from U.S. Provisional Pat. Application No. 63/276,061 filed 5 Nov. 2021, the contents of which are incorporated herein by reference in their entirety.

### FIELD OF THE INVENTION

The present invention, in some embodiments thereof, relates to system and methods for report generation, and, more particularly, but not exclusively, to a system and method for analyzing physical sites and generating associated reports.

### BACKGROUND OF THE INVENTION

Report generation tools and applications generally allow users to generate reports for use with existing data sets. Some tools allow users to manually insert data and associated visualizations into specific portions of a report and add the corresponding visualizations. Further notes and explanations can then be added manually. Others allow for portions of the reporting document to be generated automatically, such as visualizations of objects. The visualizations are based on an existing set of data, and can be placed into the generated reporting document based on user direction.

### SUMMARY OF THE INVENTION

An aspect of the present invention relates to a computer-implemented method of generating interactive site reports, the method including acquiring data associated with a specific site, generating three-dimensional images of the site, generating markings to enable a user to access detailed information regarding the site, and displaying the information on a computing device.

In some embodiments, the method further includes acquiring said data in a professional report.

In some embodiments, displaying is through a graphics unit interface (GUI) on the computing device.

In some embodiments, the data includes two-dimensional images of the site.

In some embodiments, the data includes three-dimensional images of said site.

In some embodiments, the data includes open expert data.

In some embodiments, the data includes individual expert data.

In some embodiments, the method further includes providing detailed information to the user responsive to clicking on the markings.

An aspect of the present invention relates to an interactive site analysis report generation system including a graphic unit interface (GUI) for acquiring data associated with a specific site, for generating three-dimensional images of the site, and for displaying the information on a computing device, and a site analyzer to generate markings to enable a user to access detailed information regarding the site on the GUI.

In some embodiments, the data is acquired in a professional report. the data In some embodiments, the data includes two-dimensional images of the site.

In some embodiments, the data includes three-dimensional images of said site.

In some embodiments, the data includes open expert data.

In some embodiments, the data includes individual expert data.

In some embodiments, the system provides detailed information to the user responsive to clicking on said markings.

### BRIEF DESCRIPTION OF THE DRAWINGS

Some embodiments of the invention are herein described, by way of example only, with reference to the accompanying drawings. Details shown are for exemplary purposes and serve to provide a discussion of embodiments of the invention. The description and the drawings may be apparent to those skilled in the art how embodiments of the invention may be practiced.

FIG. 1 schematically illustrates a block diagram of an exemplary interactive site analysis report generation system (ISARG) which may be used to practice the teachings disclosed herein, according to an embodiment of the present invention;

FIG. 2 schematically illustrates an RGE of FIG. 1, according to an embodiment of the present invention;

FIG. 3 is a flow diagram of a method of interactive site analysis report generation, according to an embodiment of the present invention; and

FIGS. 4 to 43 schematically illustrate exemplary scenes displayed on a graphics unit interface (GUI) which may be used with all ISARG user computing devices, according to an embodiment of the present invention.

### DETAILED DESCRIPTION

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

### Definitions

“Expert” - a real estate appraiser, lawyer, construction engineer, urban inspector, enforcement, policing, security and safety professional or any other party whose professional opinion directly connects to findings gathered at a site and/or arena, and whose professional opinion comprises an integral part of his impression of the findings at the site and/or arena.

“Interactive condensing” - computerized information files such as, but not limited to, video clips, 360-degree video clips, PDF files, computerized documents, high quality photographs, 2D (two-dimensional) images, 3D (three-dimensional) images, computerized simulation images, sound files, graphic markings, among other data sources.

The present invention is directed to a system and method for generating an interactive site analysis report which provides a user with a 3D, up to 360°, virtual tour of a site and/or arena (including surrounding areas). The interactive site analysis report (hereinafter may also be referred to as interactive report), allows a user to access points of interest (hereinafter, marking points) identified in the virtual tour, optionally predetermined marking points, and to access information associated with the site and/or arena at the marking points. Optionally, the marking points may be introduced by the user.

Exemplary applications of the system and method are shown herein with respect to forensic analyses and real estate appraisal analyses. Nevertheless, the skilled person may readily appreciate that the number of applications may be numerous, and therefore not limited to those shown herein.

The generated interactive report may include the 3D, up to 360°, virtual tour of a site and/or arena which may be displayed to the user, and optionally, an expert professional opinion/report prepared by a professional which references the marking points shown in the virtual tour. The user may access the information in the report through the marking points shown at the site and/or arena in the virtual tour, and inversely, the user may access the marking points in the site and/or arena through the marking points introduced into the professional opinion/report. For convenience hereinafter, the terms “opinion” and “report” may be used interchangeably.

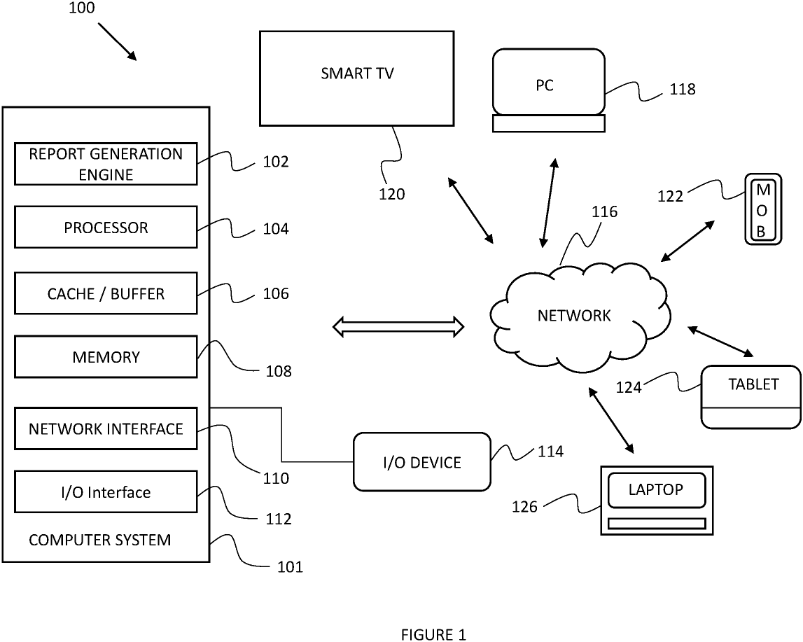

Reference is now made to FIG. 1 which schematically illustrates a block diagram of an exemplary interactive site analysis report generation system (ISARG) 100 which may be used to practice the teachings disclosed herein, according to an embodiment of the present invention. ISARG 100 may include a computer system 101 including a Report Generation Engine (RGE) 102, a processor 104, a cache/buffer 106, a memory 108, a network interface 110, an I/O interface 112, at least one I/O device 114. ANS 100 may additionally include a plurality of computing devices, for example, computing devices which may include PCs 118, smart TVs 120, mobile phones 122, tablets 124, and laptops 126.

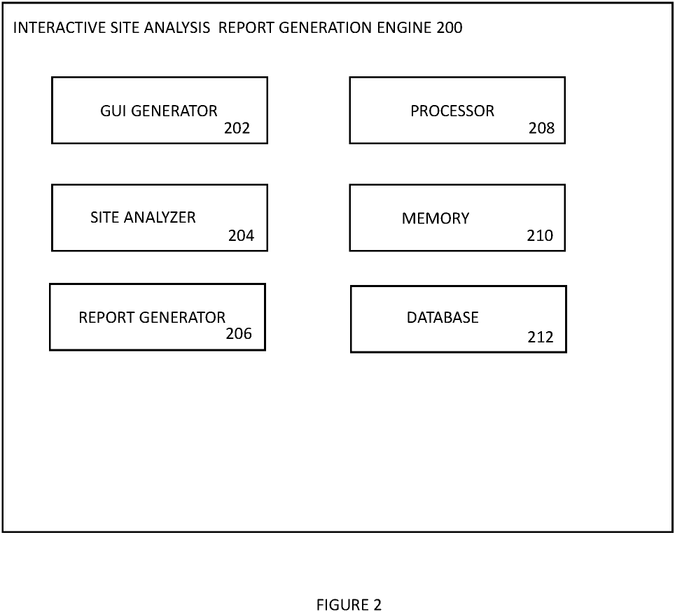

RGE 102 may include the GUI to provide the platform for the users to view sites and view and/or access data associated with the sites. The GUI may be implemented in the plurality of computing devices 118 - 126. The components of RGE 102 and its functioning is described in greater detail hereinafter with reference to RGE 200 shown in FIG. 2 and associated description.

Processor 104 may be a computing device for executing hardware instructions or software, and may include those stored in memory 108. Processor 104 may be any custom made or commercially available processor, a central processing unit (CPU), an auxiliary processor among several processors associated with computer system 101, a semiconductor based microprocessor (in the form of a microchip or chip set), a macro processor, or generally any device for executing instructions. Processor 104 may include a cache/buffer 106. Processor 104 may be configured to execute instructions stored within memory 108, to communicate data to and from the memory 108, and to generally control operations of computer system 101 pursuant to the instructions.

Memory 108 may include any one or combination of volatile memory elements (e.g., random access memory RAM, such as DRAM, SRAM, SDRAM, etc.) and nonvolatile memory elements (e.g., ROM, erasable programmable read only memory EPROM, electronically erasable programmable read only memory EEPROM, programmable read only memory PROM, tape, compact disc read only memory CD-ROM, disk, diskette, cartridge, cassette or the like, etc.). Moreover, memory 108 may incorporate electronic, magnetic, optical, and/or other types of storage media. Optionally, memory 108 may have a distributed architecture, where various components are situated remote from one another, but may be accessed by processor 104.

The instructions in memory 108 may include one or more separate programs, each of which may include an ordered listing of executable instructions for implementing logical functions. In the example of FIG. 1, the instructions in memory 108 may include any suitable operating system. The operating system may essentially control the execution of other computer programs and may provide scheduling, input-output control, file and data management, memory management, and communication control and related services.

Network interface 110 may serve to connect computer system 101 to a network 116. Network 116 may be an IP-based network for communication between computer system 101 and computing devices 118 - 126 and may transmit and receive data between the ANS and the computing devices. Optionally, network 116 may be a managed IP network administered by a service provider. Network 116 may be implemented in a wireless fashion, e.g., using wireless protocols and technologies, such as Wi-Fi, WiMAX, etc. Network 116 may also be a packet-switched network such as a local area network, wide area network, metropolitan area network, Internet network, or other similar type of network environment. Network 116 may be a fixed wireless network, a wireless local area network (LAN), a wireless wide area network (WAN) a personal area network (PAN), a virtual private network (VPN), intranet or other suitable network system and may include equipment for receiving and transmitting signals. Network 116 may be a mobile phone network.

I/O interface 112 may serve to output processed data to an output device connected to computer system 101 and to receive data entry from an input device, both devices shown generically in the figure as I/O device 114. I/O device 114 may include a display, a conventional keyboard and mouse, a scanner, a printer, an imaging device, a microphone, among many other devices which may serve to either output processed data or may be used for data entry. I/O device 114 may further include devices that communicate both inputs and outputs, for example, a network interface card (NIC) or a modulator/demodulator, a radio frequency (RF) or other transceiver, a telephonic interface, a bridge, a router, and the like.

Reference is now made to FIG. 2 which schematically illustrates an RGE 200, according to an embodiment of the present invention. RGE 200 may be similar to RGE 102 and may include a GUI generator 202, a site analyzer 204, a report generator 206, a memory 208, a processor 210, and a database 212.

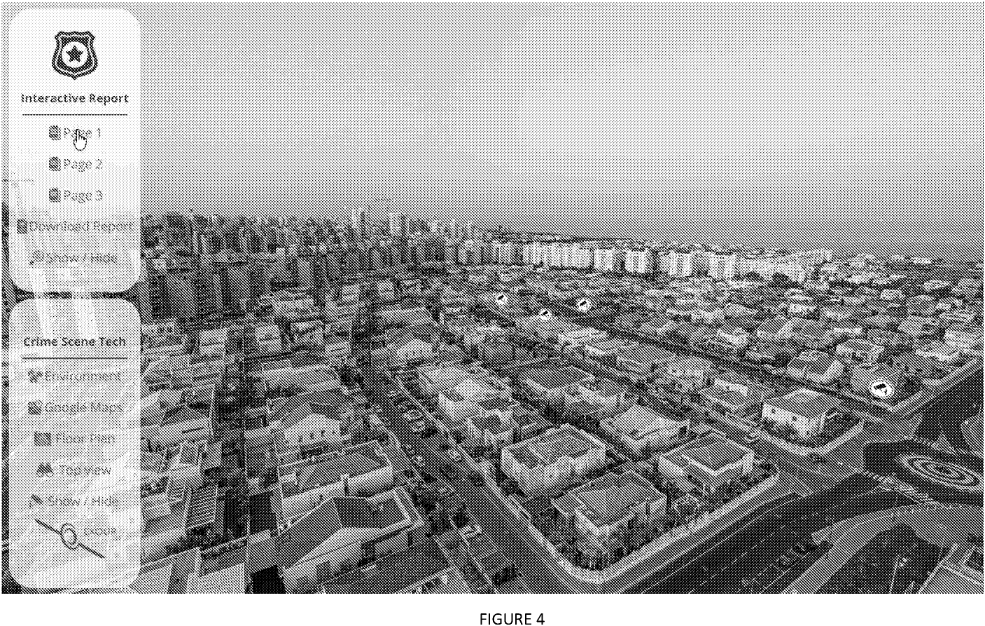

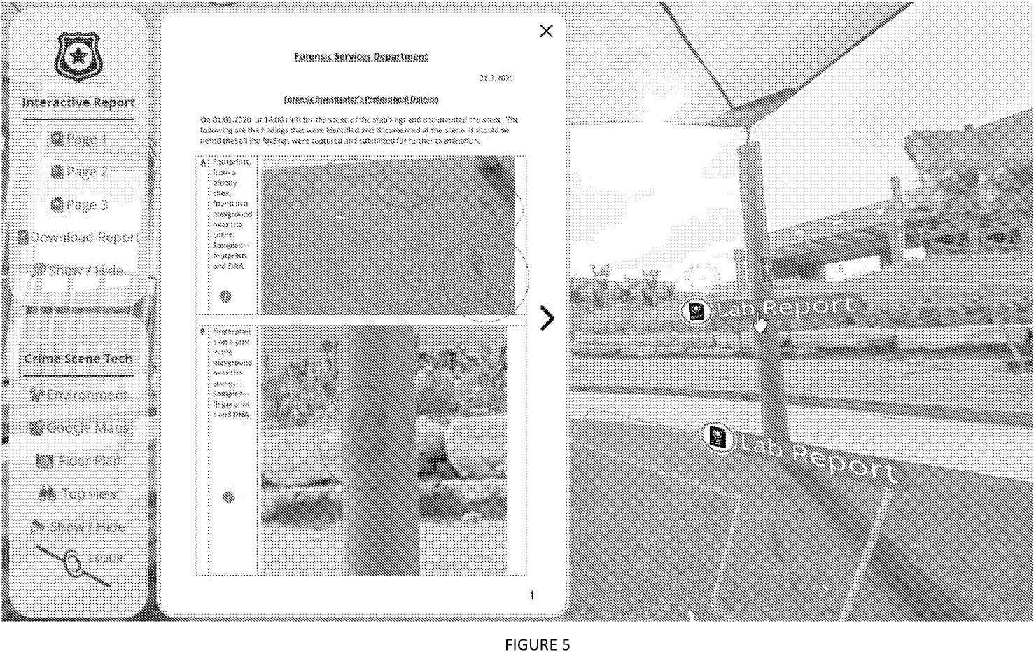

GUI generator 202 may generate the GUIs in the computing devices of all ISARG users. It may generate the data displayed by the GUIs and may process data input by a user through the user’s computing device GUI. It may also serve to interface between the GUIs of the computing devices and the other components in RGE 200, including site analyzer 204 and report generator 206. A description of an exemplary GUI is provided further on below with reference to FIGS. 4 - 43.

Site Analyzer 204 may interface with GUI generator 202 to display all sites, all of which may be displayed to users through their computing device GUI. Site Analyzer 204 may additionally allow users to access marking points and to further close in on details which may be associated with the marking points and sites which may be of interest. Site analyzer 204 may provide the site information to GUI generator 202 which may display the information to users through their computing device GUI. Site information used by site analyzer 204 may be internally stored inside the site analyzer or alternatively, may be stored in database 212. The stored information may be retained permanently, or may be stored for a predetermined amount of time, for example, until a report is generated or alternatively, for a week, a month, a year, or longer.

Report generator 206 may also interface with GUI generator and may process all acquired data associated with sites of interest from users and may generate interactive reports associated with the sites of interest through the GUI of the computing device. Information associated with the sites may be optionally input by the users through their computing device GUI, based on the type of report to be generated. Report generator 206 may instruct GUI generator 202 to display the interactive site data on the GUI of user computing devices.

Processor 208 may control the operation, including the interfacing, of all components in RGE 200 and may interface with processor 104 in computer system 101 for data transfer between the RGE and other components of the computer system. In some embodiments, the functions carried out by processor 208 may be provided by processor 104. The instructions required by processor 208 to execute its control and interfacing functions may be stored in memory 210.

Database 212 may store site related information which may include historical data, visually acquired data (2D and 3D images), manual and automatic reports which may be provided by the users or third parties, and other stored data as may be relevant to generate an interactive site analysis report. Database 212 may additionally include details associated with each ISARG user, for example, user registration information, user authentication information, user payment information, user transaction information, among other user information generally collected in subscriber-based on-line platforms.

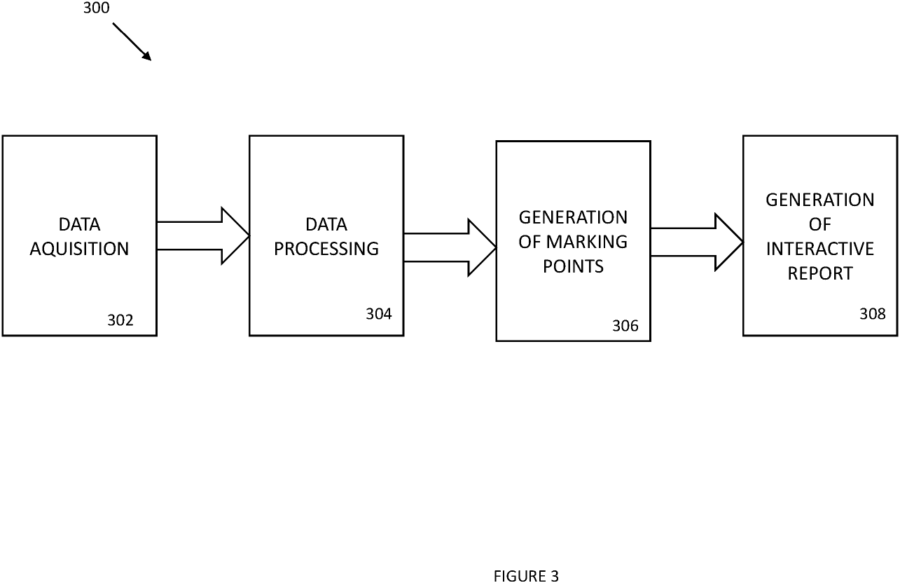

Reference is now made to FIG. 3 which is a flow diagram of a method of interactive site analysis report generation 300, according to an embodiment of the present invention.

At 302, data acquisition may be performed. Data acquisition may include a professional opinion/report which may be in the form of a PDF file, Word file or other suitable format. It may include scenery documentation which may include a series of 2D and/or 3D images which document a view of the site and/or arena, and the surrounding area, optionally a 360 degree view. Optionally, the data acquisition may include interactive condensing. The interactive condensing may include additional files and documents, and any information and/or reference which may provide information on the content of the professional opinion/report, support the arguments cited there, clarify issues that cannot be conveyed by verbal means alone, such as video clips, sound files, 2D and 3D models, simulations, recordings, and high resolution video and still photography images, additional professional opinions, links to web sites, among other sources of information. Optionally, the acquired data may be stored in database 212. The acquired data may be uploaded to system by users through their user computing devices and/or at server level.

At step 304, the acquired data may be processed, including images and interactive information. The step may include scanning of 3D and 2D images that document the 360° view of the site and/or arena for creating an interactive virtual tour which contains all the information provided by the users Optionally, other types of images may be used, for example, infrared images, ultrasound images, among other types of images. Optionally, a written opinion or report, for example, an assessment report, may be processed, where every page of the opinion/report may be scanned, and system 100 may define points suitable for “interactive condensing.” Optionally, the processed data may be divided into two categories, open expert data and individual expert data.

Open expert data may include data relating to a geographic location, the physical position on the site, the arena etc. Any user may add to the relevant information connected to them through open means, such as web sites with mapping data, GIS and general information that is available on the site from various sources of information. Optionally, through the GUI, individual expert data may be processed which may include information which is directly connected to the findings which were available to the user during their visit to an asset, site and/or arena, and on which the user’s opinion is based The information may be actively condensed and/or may be carried out using material documented and/or gathered by the users at the site and/or arena, by any means he or she chooses. This may serve the purpose of substantiating the content of a professional opinion/report, presenting the factual data noted in it and/or the expert’s considerations in accordance with their viewpoint and the manner in which they choose to present them in their professional opinion/report.

Data Processing may be done on-line through the network 116. Optionally, may be done off-line by the user computing devices (PC, Mobile, Tablet, Laptop, Other User Computing Devices) 114, 118, 120, 122, 124 and 126.

At 306, the system may highlight graphic markings on the professional opinion/report, as well as on the virtual tour, of the open and individual expert data whereby each mark acts as a link and/or means of graphically highlighting and transferring information associated with the professional opinion/report. The user may be presented with a professional opinion/report with clear markings/links which facilitate highlighting and condensing of the expert’s data. The user may access the relevant section of the site and/or arena by clicking on any marking/link. Optionally, if the user decides to complement his considerations, relating to a particular point, also using interactive condensing, the user may be allowed the opportunity to operate the interactive condensing files for the particular point in the professional opinion.

At 308, generation of the marking may include highlighting the graphic marking on the professional opinion/report, as well as on the virtual tour, of the open and individual expert data whereby each mark acts as a link and/or means of graphically highlighting and transferring information associated with the professional opinion/report. The user may be presented with a professional opinion/report with clear markings/links which facilitate highlighting and condensing of the expert’s data. The user may access the relevant section of the site and/or arena by clicking on any marking/link. Should the expert decide to complement considerations, relating to a particular point, also using interactive condensing, the user may be allowed the option to operate the interactive condensing files for the particular point in the professional opinion.

At 310, the system may enable the user to gain an impression of the documented physical data, of the site and/or arena, similar to the impression gained by the expert while drafting the professional opinion/report. This may also offer the possibility of continuing to move around the entire site and/or arena in a virtual manner. The professional opinion, with graphic markings as noted above, and the interactive virtual tour, may provide for a system and method for interactive virtual site analysis.

The interactive virtual site analysis including viewing of the interactive report may include use of user computing devices which may include virtual reality (VR), augmented reality (AR), mobile phones, PCs, laptops, tablets, etc., and may allow access through the web. Intra-system communications may include known communication networking technologies and communication means (wireless/wired).

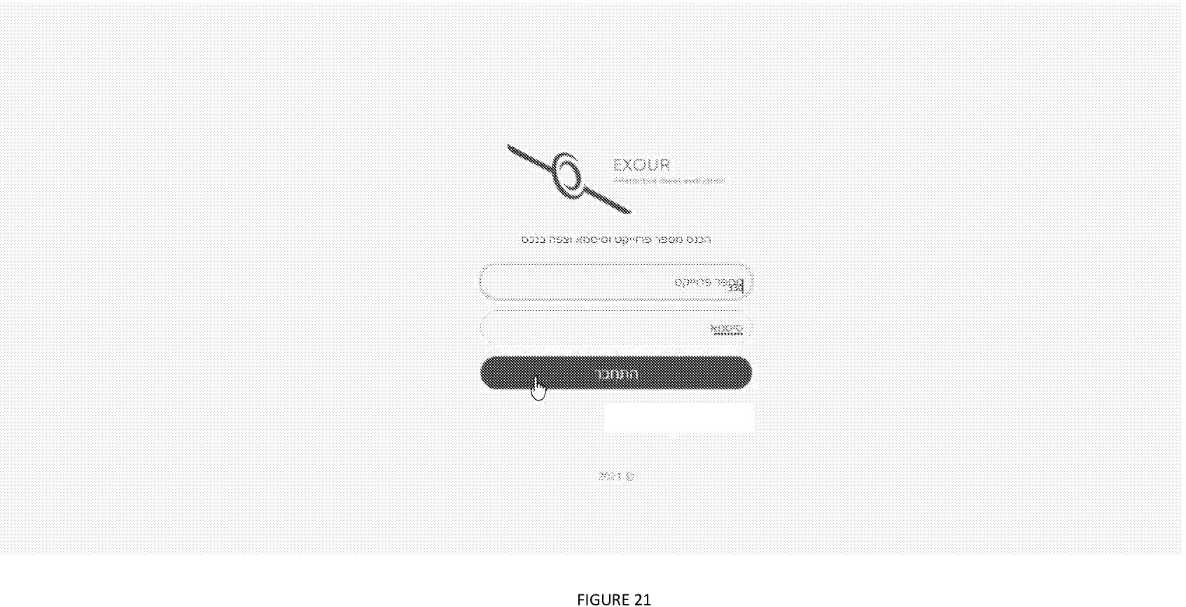

Reference is now also made to FIGS. 4 to 43 which schematically illustrate exemplary layouts for GUI 202 which may be used with all ISARG user computing devices, according to an embodiment of the present invention. FIGS. 4 - 20 show exemplary layouts for GUI 202 operation for generating an interactive report for forensic analyses, and FIGS. 21 - 40 show exemplary layouts for the GUI operation for generating an interactive report for real estate appraisal analyses The figures are intended to show the operation of the ISARG in different possible scenarios and are not intended to be limiting in any way or form. The skilled person will immediately realize that there may be a countless number of scenarios which may occur during sessions involving of interactive site analysis that the ISARG may be used in all of these scenarios. It is also noted that the figures are exemplary and that there is no intention to connect the figures to authentic locations or images.

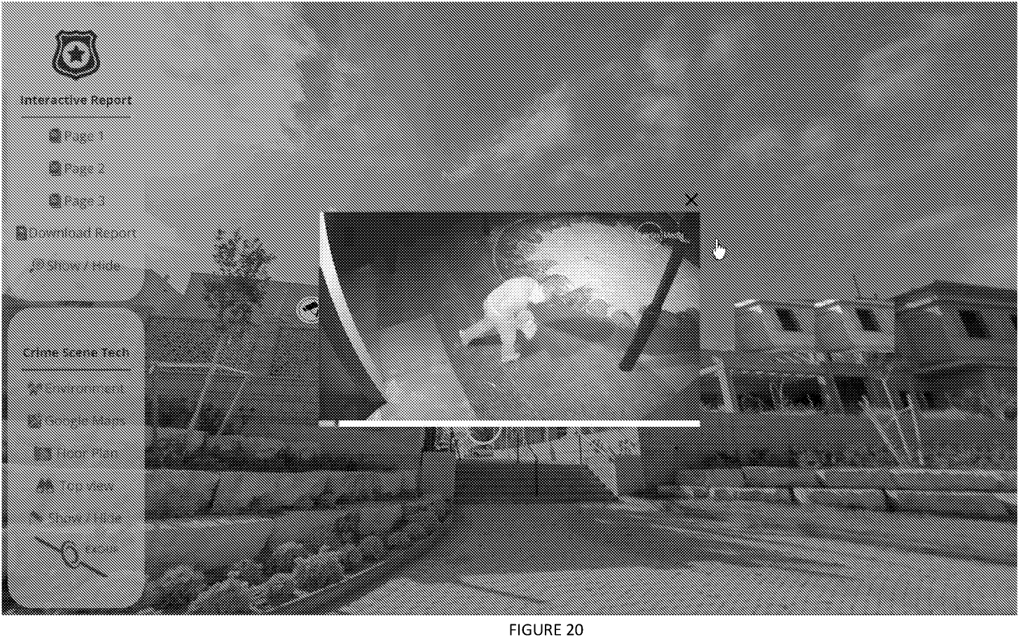

FIG. 4 shows using the GUI to open a screen including a 360 degrees bird’s eye view of an exemplary general site. Also shown in the screen is an exemplary Interactive Report menu and an exemplary Crime Scene Tech menu. Accessible through the Interactive Report menu are a Page 1 button, Page 2 button, Page 3 button, Download Report button, and Show/Hide button. Accessible through the Crime Scene Tech menu are an Environment button, Google Maps button, Floor Plan button, Top View button, and Show/Hide button. Description of the function of each button is provided herein below with reference to the figure and further on below with reference to FIGS. 5 - 20. The user may navigate through the interactive report by clicking on a page, for example, as shown in the figure by the movable cursor symbol of the “hand” pointing at Page 1 under the list titled “Interactive Report” which links the user to page 1. The user may press on a professional opinion button to receive an opinion. The video camera symbols represent areas of interest which are imaged from close up as part of the interactive report, as described further on below with reference to the FIGS. 19 and 20.

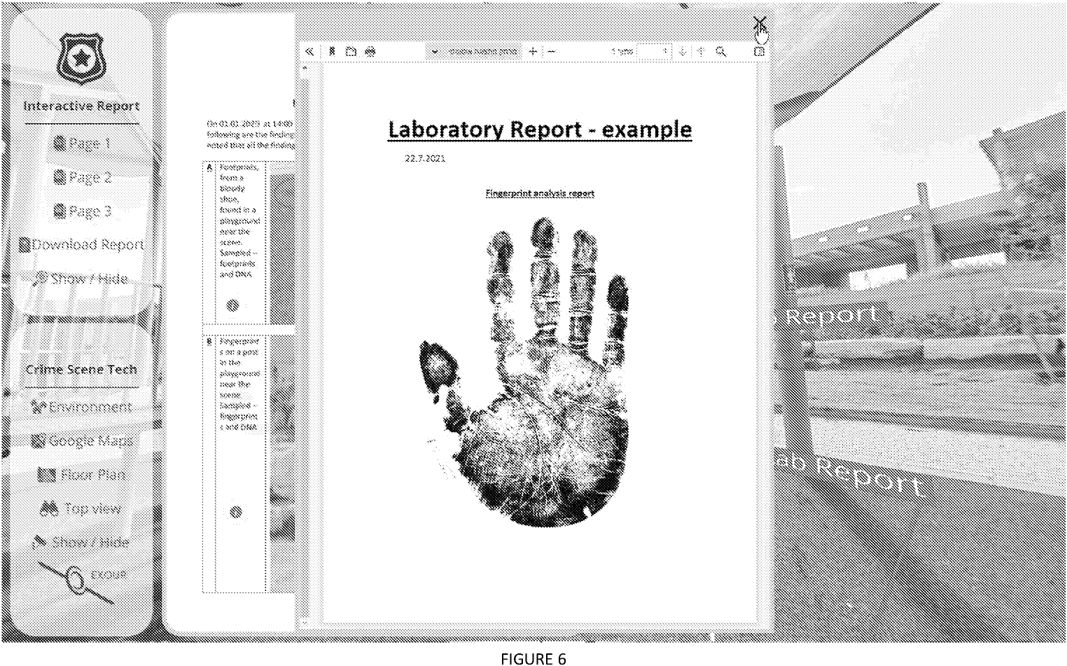

FIG. 5 shows using the GUI to display the professional opinion. By the user clicking on the first section of the professional opinion, as shown by the “hand” pressing on the graphic button, a 360 degrees display of the relevant spot on the site is opened in the background, and the graphic tools to show the relevant location, shown by the geometric shapes on the column and the ground, and also identified by the flags “Lab Report” at the respective locations. Clicking on the laboratory report flag may also take the user to the next page (FIG. 6), as shown by the “hand” on the “Lab Report”.

FIG. 6 shows using the GUI to display a Laboratory Report, for example, a PDF file, which shows the results of laboratory tests relating to the point of interest being viewed.

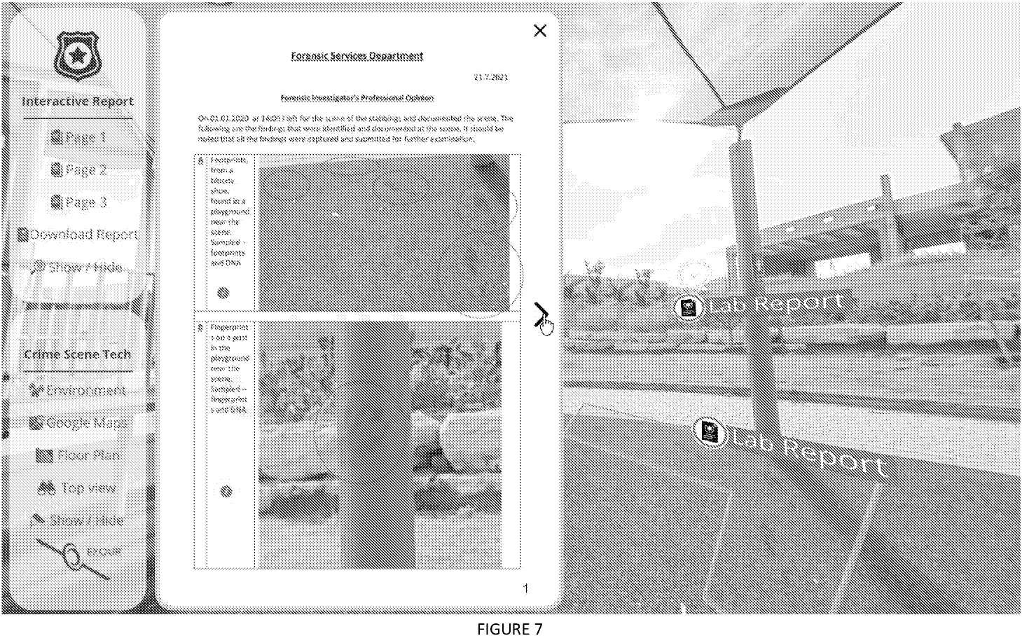

FIG. 7 shows using the GUI to scroll to any location on the professional opinion being viewed by moving the “hand” to the right-hand pointing marker and clicking on the marker.

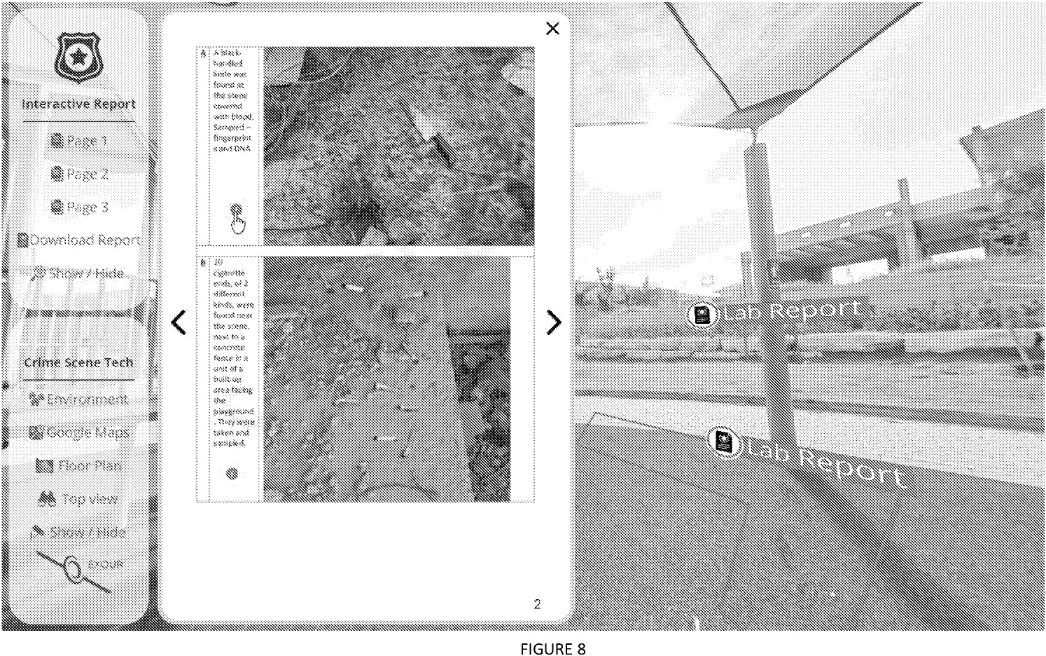

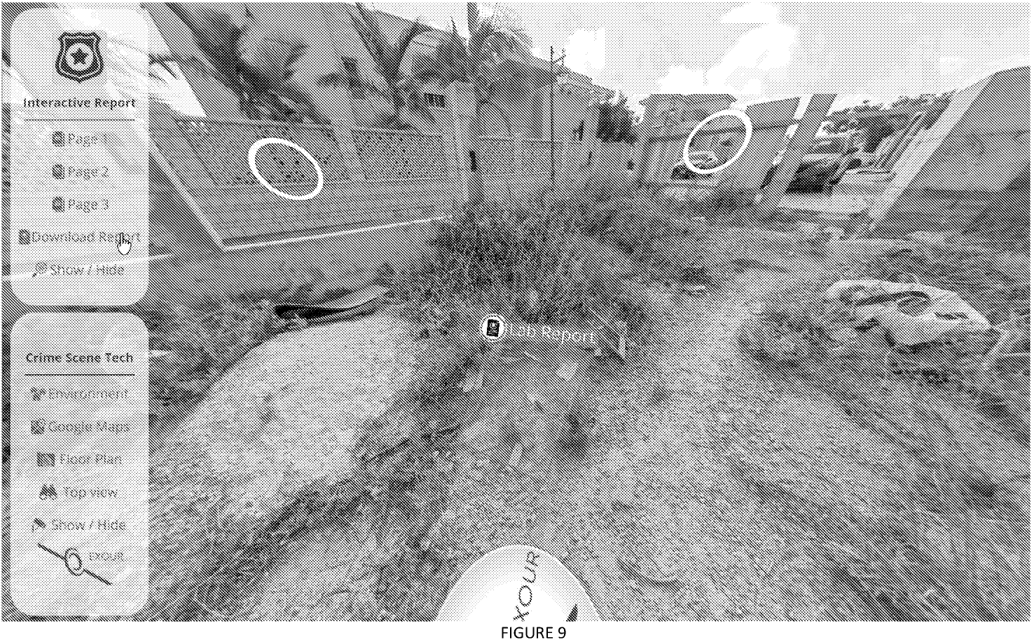

FIG. 8 shows using the GUI to move on to another chosen section of the professional report and displaying the section. The user may then move the “hand” to the desired scene, as shown by the “hand” in scene A, and by clicking on the scene to obtain a view of the spot on the site as shown by FIG. 9.

FIG. 9 shows using the GUI to display opening a 360 degrees display of the relevant spot on the site, and the graphic tools to show the relevant location. Circular markers indicate areas of interest which may be immediately accessed by clicking on the marker. A lab report associated with the findings at the location may be accessed by clicking on the “La Report” flag.

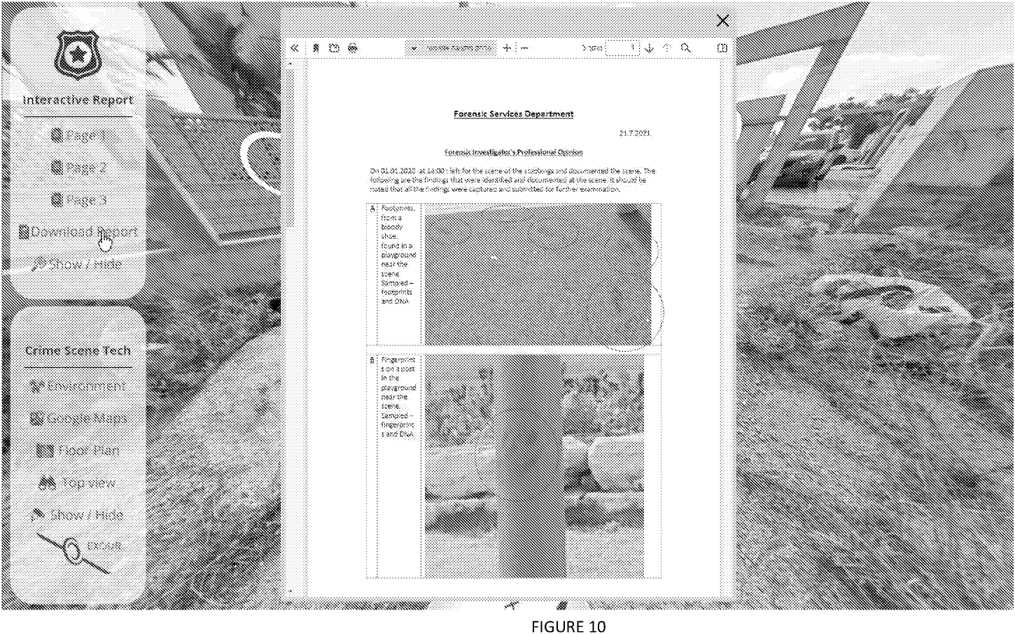

FIG. 10 shows using the GUI to download the interactive report, optionally the professional report, by selecting the Download Report button, which may optionally be non-interactive for printing or saving files.

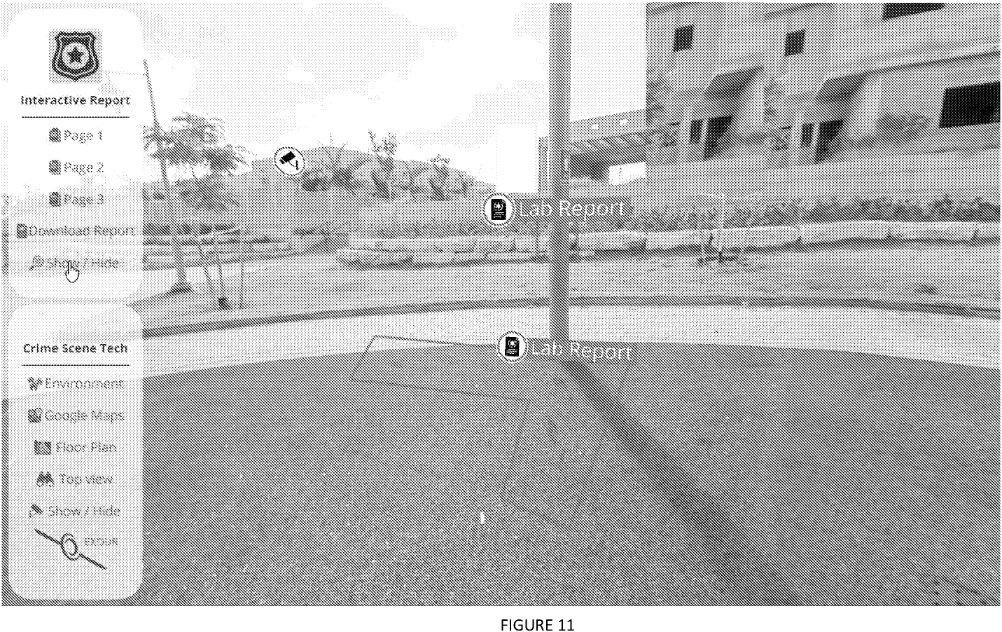

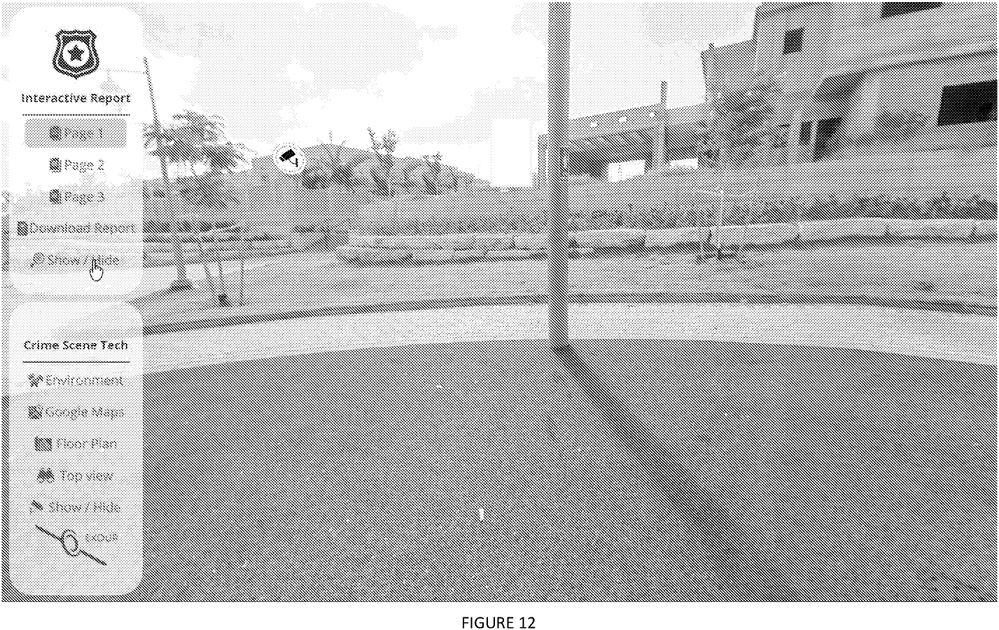

FIG. 11 shows using the GUI to display the graphic tools which may be hidden or displayed by clicking the Show/Hide button, as shown by the “hand” on the button. In this Figure, the geometric shapes and the flags are displayed. The video camera symbol in the background represents an area of interest which has been captured by video imaging.

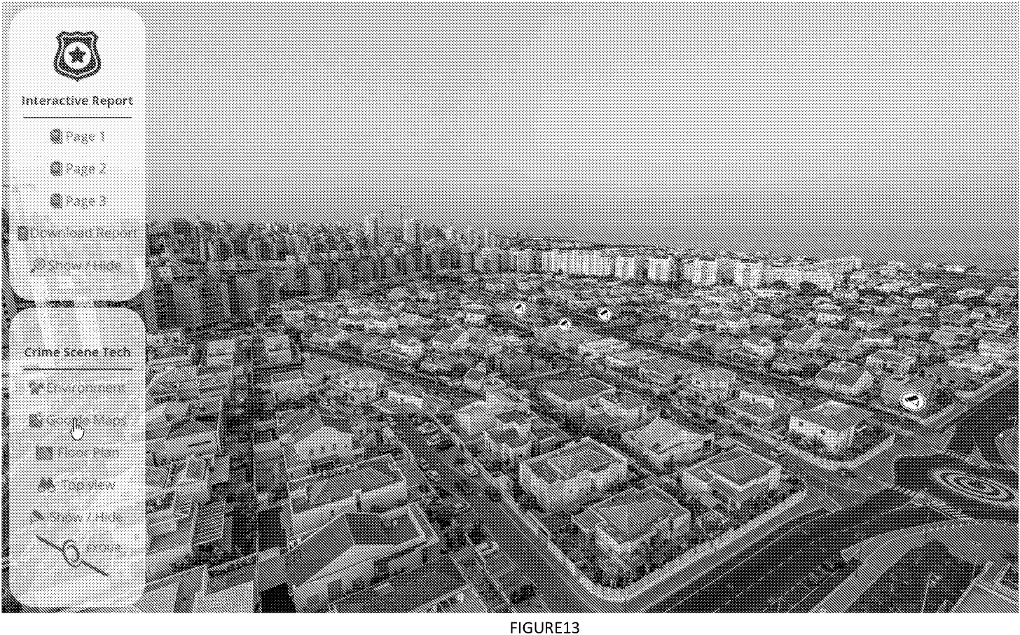

FIG. 12 shows using the GUI to display the graphic tools of FIG. 11 which are hidden.

FIG. 13 shows using the GUI to display the surroundings to provide a 360 degrees view of the general location site when the Environment button is clicked, as shown by the “hand” on the button.

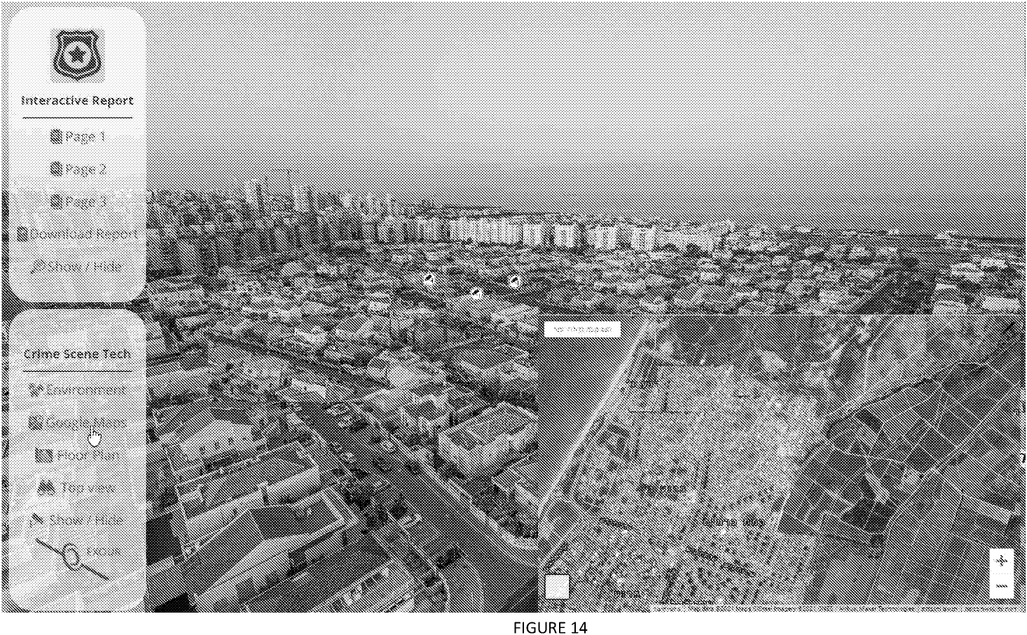

FIG. 14 shows using the GUI to display a Google maps view of a larger general area when the Google Maps buttons is clicked, as shown by the “hand” on the button, and which may be accessed to find a location on the general site.

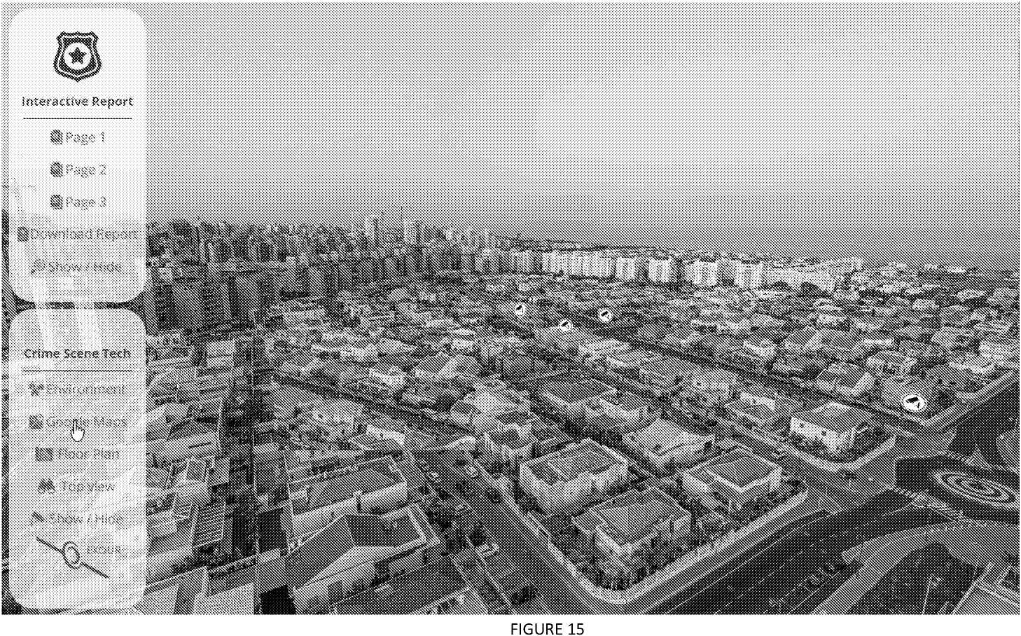

FIG. 15 shows using the GUI to display the general site from a bird’s eye view by clicking on the Top View button, as shown by the “hand” on the button, including graphic markings in relation to their actual location on site as shown by the video camera symbols.

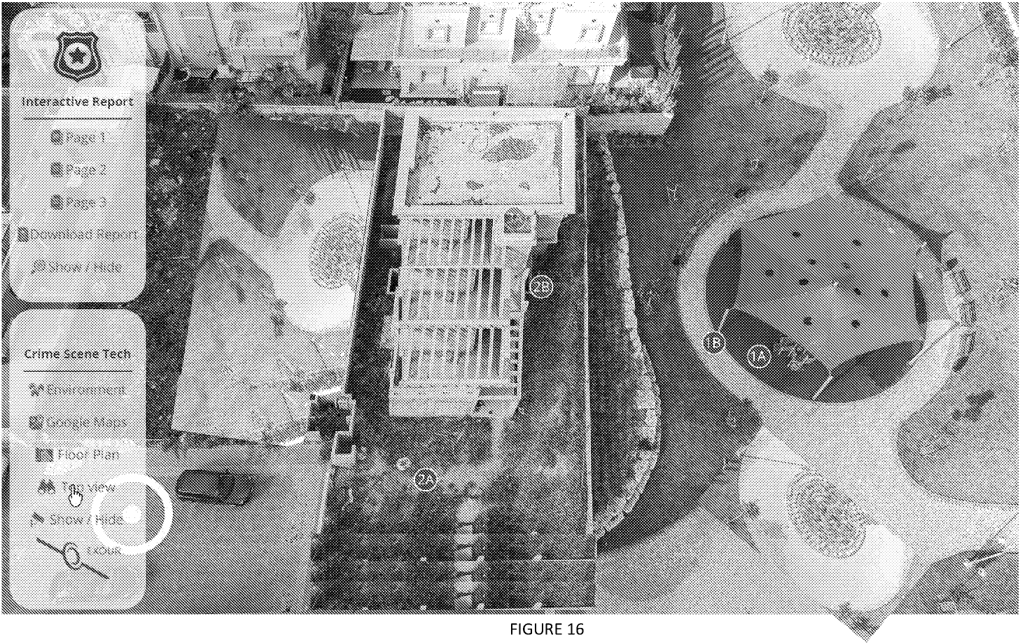

FIG. 16 shows using the GUI to display the findings from a view from above (bird’s eye view), as shown by markers 1A, 1B, 2A, 2b, and 3A for a particular location following use of the Top View button, and clicking on a sample finding associated with marker 3A, as shown by the “hand” on the respective marker.

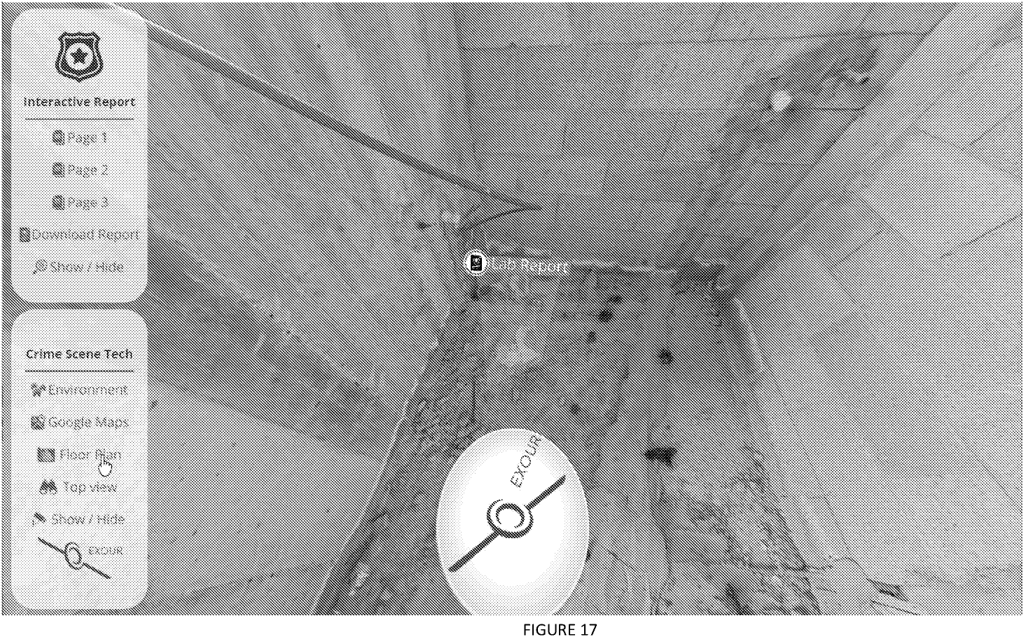

FIG. 17 shows using the GUI to display a close-up of the position associated with marker 3A, and access to Lab Report documentation of the finding by means of the “Lab Report” flag, and clicking on the Floor Plan button to find the location on site, as shown by the “hand” on the respective button.

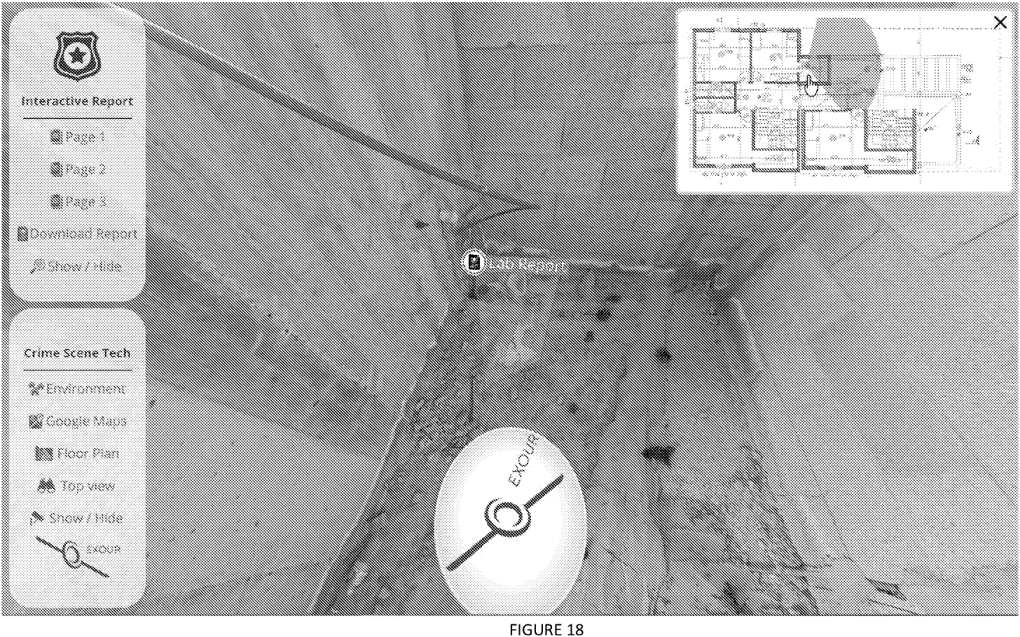

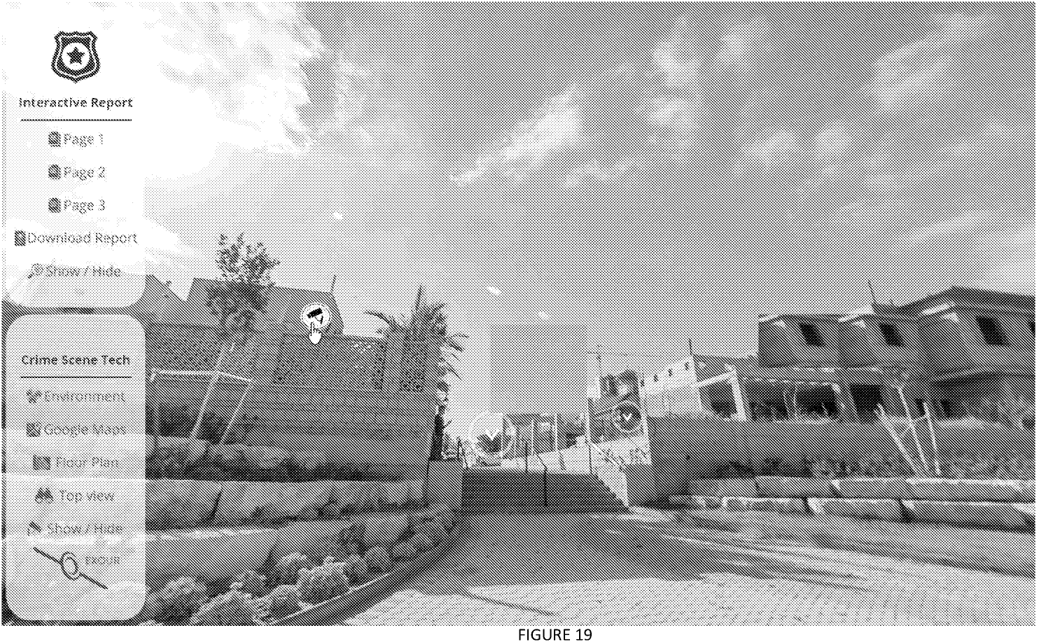

FIG. 18 shows using the GUI to display a site chart/drawing of the viewer’s position and an angle of view following clicking of the Floor Plan button from FIG. 17. It is noted that the EXOUR symbol maybe disregarded.

FIG. 19 shows using the GUI to view when a finding is obtained in relation to a particular location on the site, and a video clip which may be activated from the image taking, as indicated by the “hand” on the video camera symbol In the background may be seen two downward pointing markers which link to locations of findings, previously described with reference to FIGS. 9 and 16.

FIG. 20 shows using the GUI to actuate a video from a designated location shown in FIG. 19, and displaying of the video as part of the interactive report.

FIG. 21 shows using the GUI to display an opening page including an expert opinion titled Full Real Estate Appraisal And/or Professional Report, and an entry button ENTER to access the interactive report including the expert opinion.

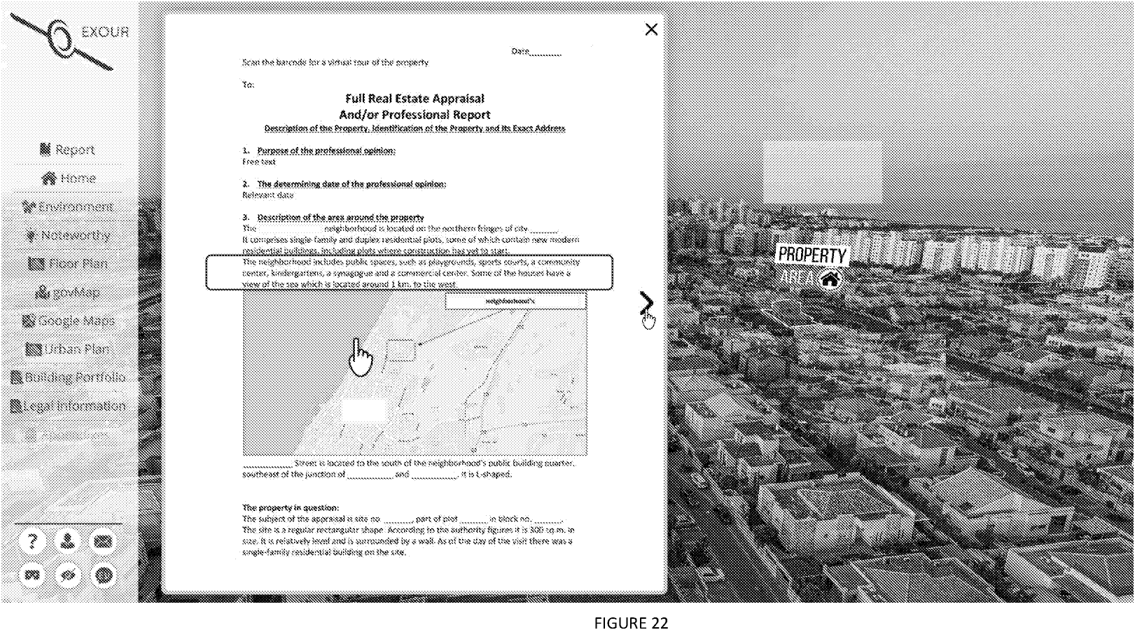

FIG. 22 shows using the GUI to display in the background a 360 degree view of a general site, and an exemplary menu including a Home button, Interactive Report button, Environment button, Google Maps button, govMap button, Floor Plan button, Download Report button, Download Appx button. This in addition to the professional opinion. Additionally shown is a Hide Menu button, and feature buttons associated with features which may be used and which may include close-up view, rotating of view, among other optional features. Description of the function of each button may be similar to that of the same button referenced with respect to FIGS. 4 - 20, or as otherwise described herein below with reference to this Figure and FIGS. 22 - 43. Also shown is using the GUI to display a window with instructions of how to move around the display using a mouse to control the “hand” and to open/close/expand/reduce windows. Additionally shown is an entry button to enter the professional opinion.

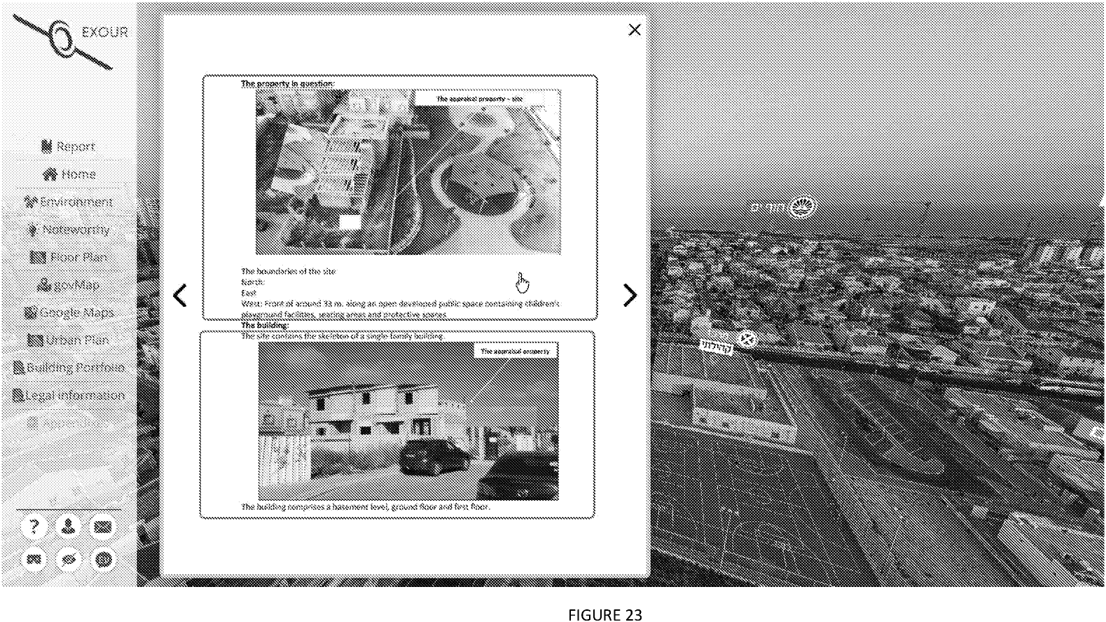

FIG. 23 shows using the GUI to display enlargement of the display by clicking on the enlargement button with the “hand”.

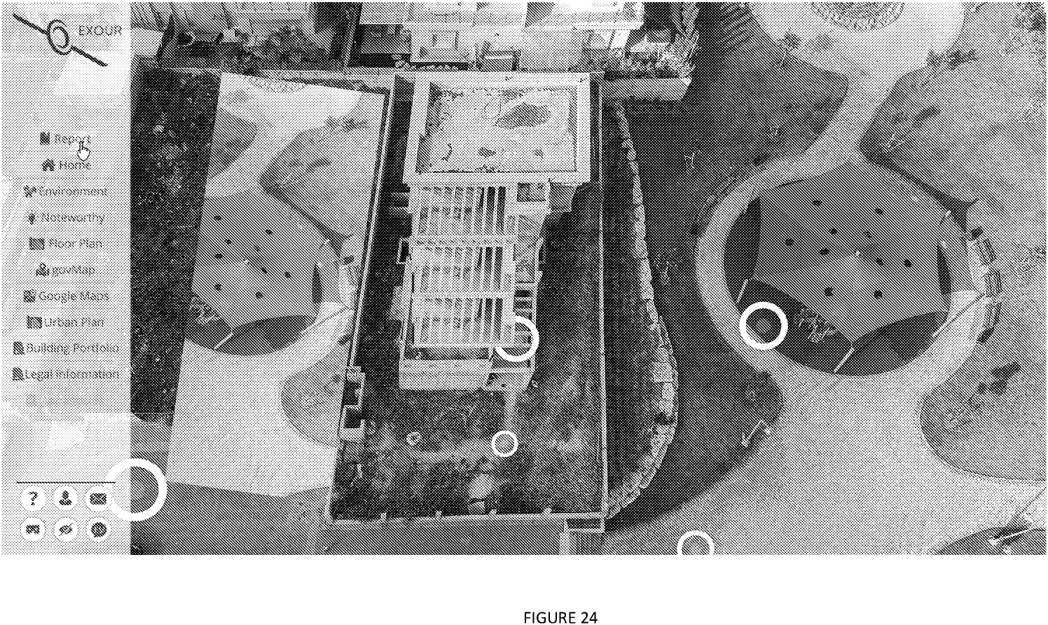

FIG. 24 shows using the GUI to provide an enlarged display of the expert opinion from FIG. 23, including partial or complete hiding of the menu, and a click on the entry button to enter the professional opinion.

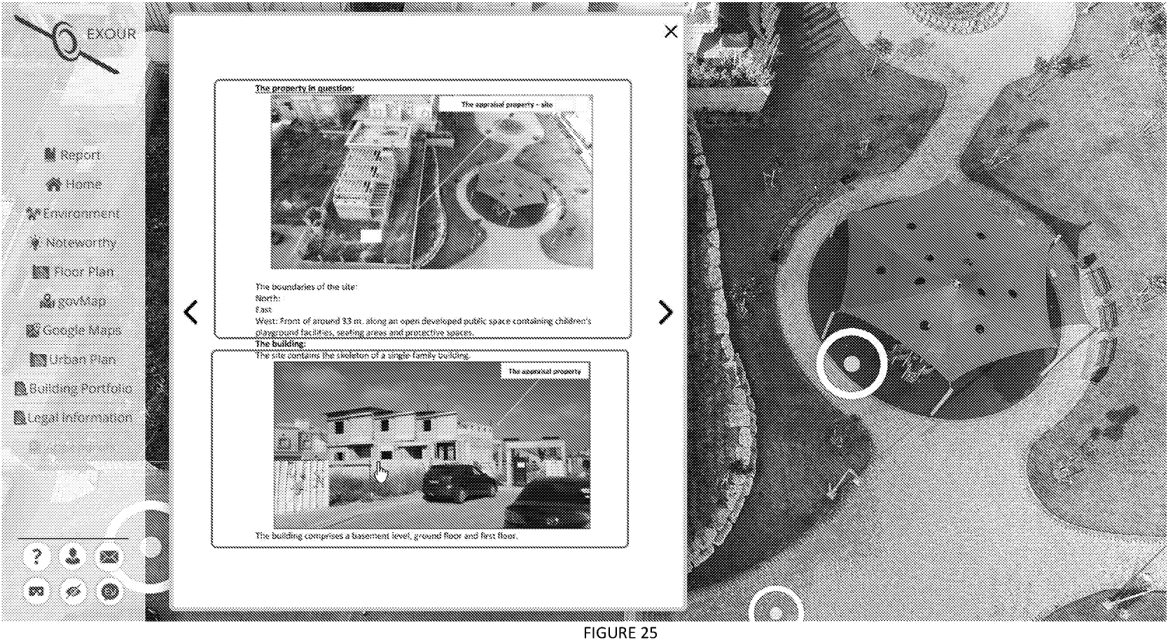

FIG. 25 shows using the GUI to display a larger area surrounding, for example, by pressing the Google Maps button, as seen by the newly opened window in the display. Also shown is using the GUI to scroll to the next page of the professional opinion, as indicated by the “hand” on the right-pointing scroll arrow on the opinion.

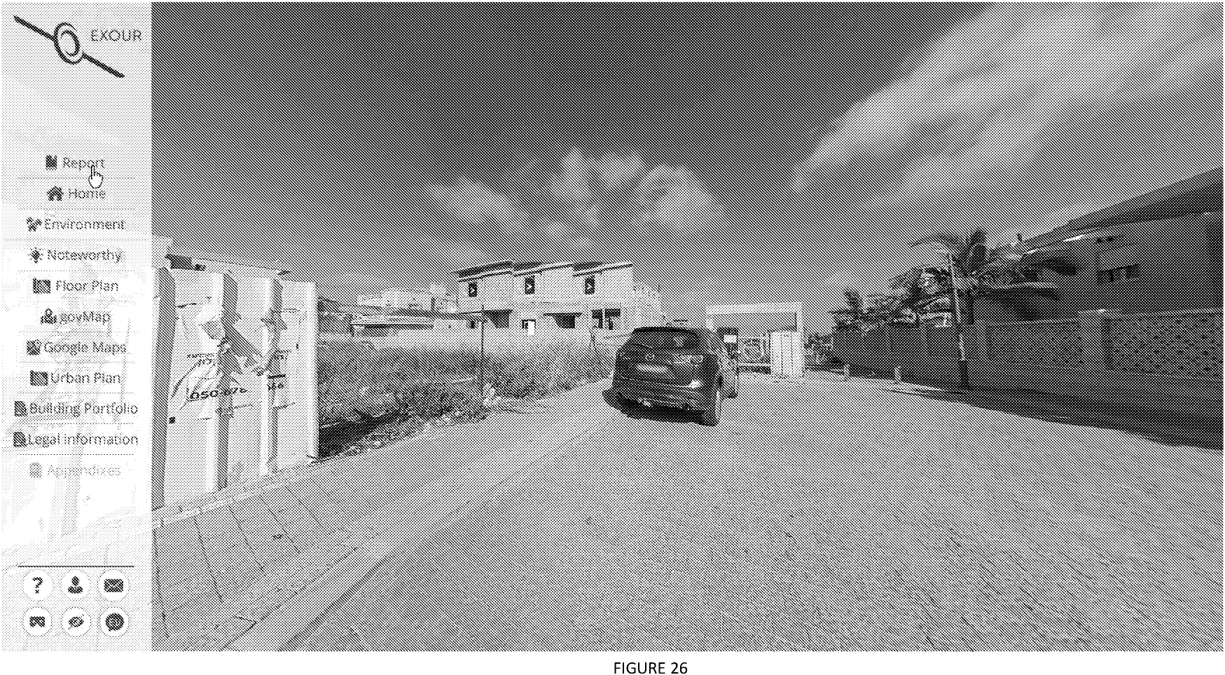

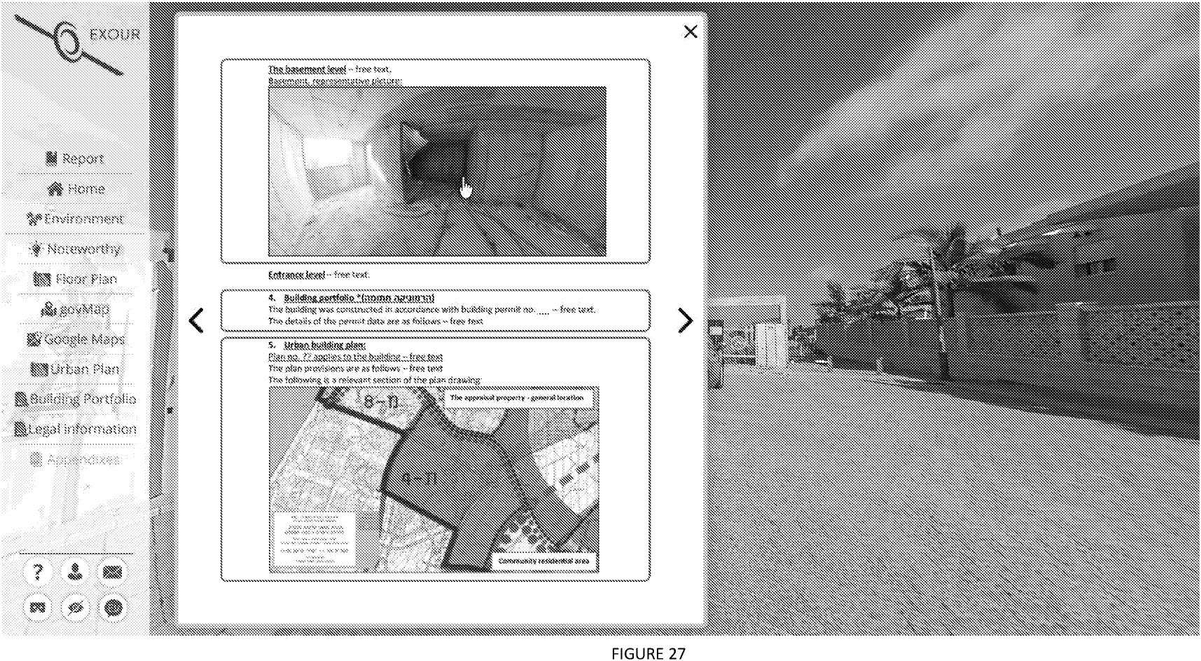

FIG. 26 shows using the GUI to access a specific place in the professional opinion which refers the reader to a specific point in the virtual tour relating to the clause in the professional opinion, as shown in FIG. 27. The “hand” is shown clicking on the button next to the desired specific point.

FIG. 27 shows using the GUI to display the specific point in the virtual tour, and scrolling to the next page. The function of the circular markers shown therein is similar to that previously described with reference to FIG. 9.

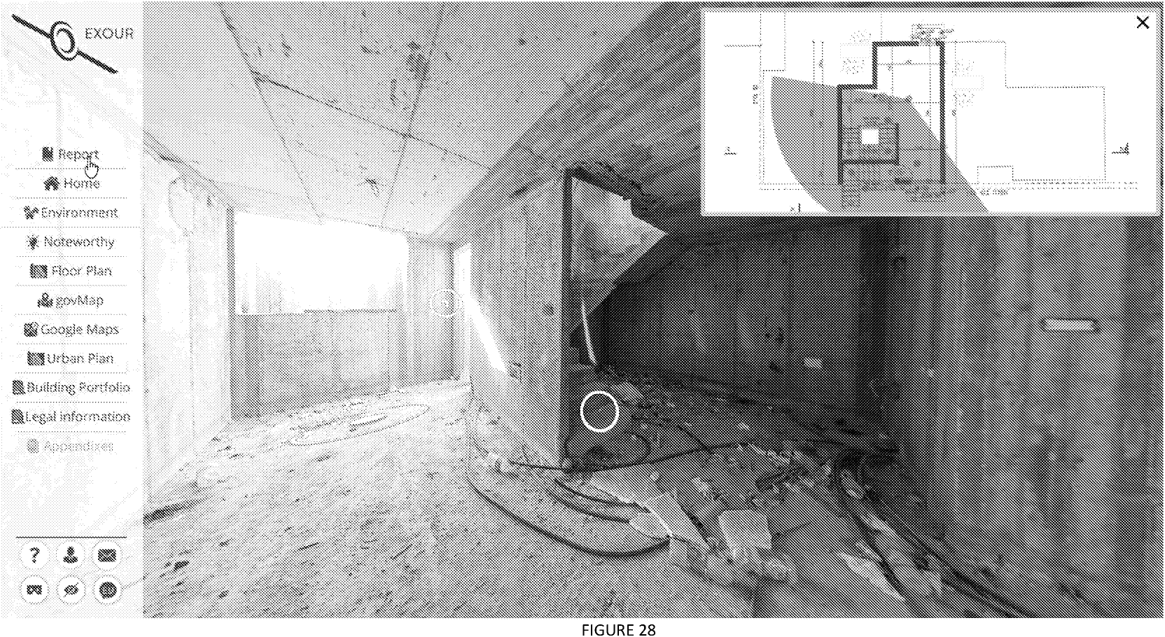

FIG. 28 shows using the GUI to refer the user to a specific point in the virtual tour relating to the clause in the professional opinion. The floor plan window on the display was opened by clicking with the “hand” (not shown) on the Floor Plan button.

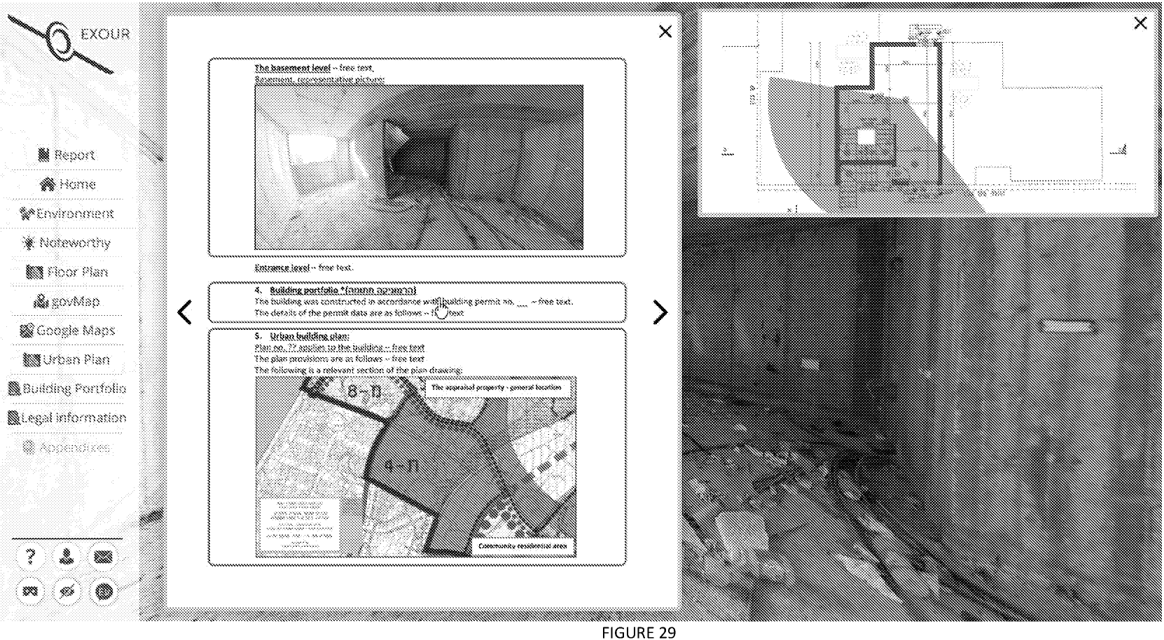

FIG. 29 shows using the GUI to open a display of a floor plan associated with a description of a relevant document mentioned in the professional opinion by clicking with the “hand” on the relevant button, as shown.

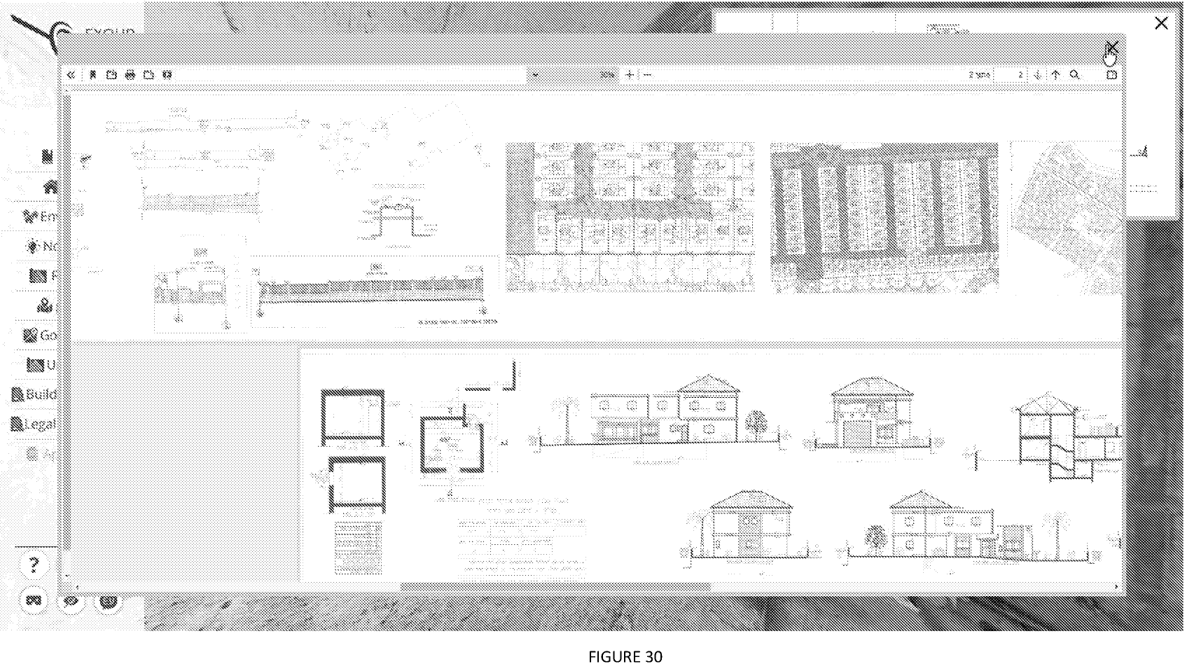

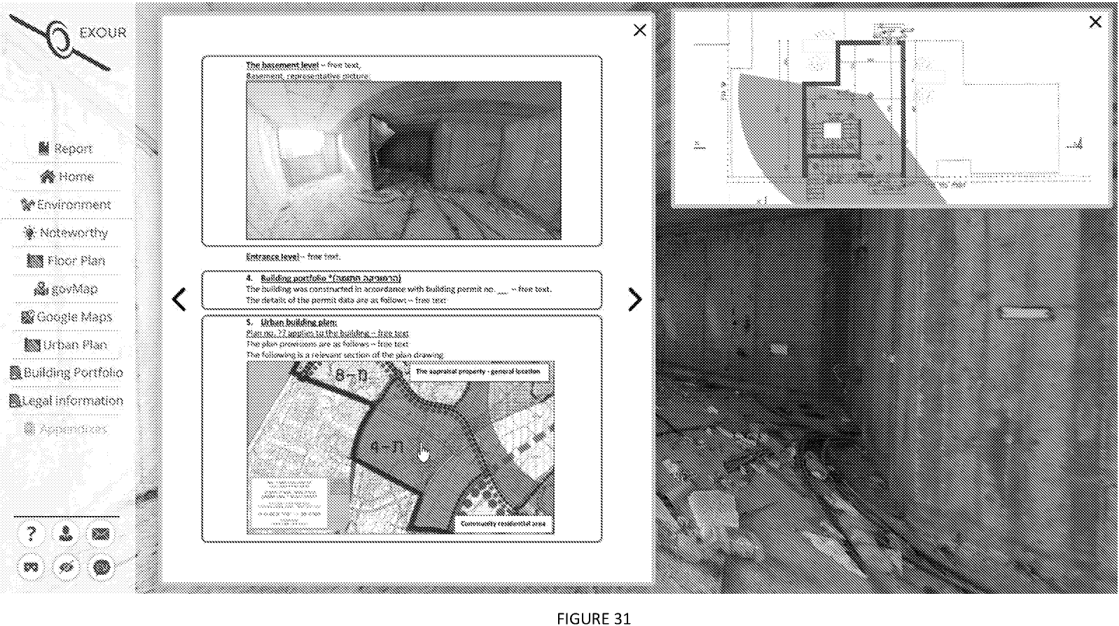

FIG. 30 shows using the GUI to display a map associated with another section of the professional opinion, as shown by the “hand” clicking on the button next to the map. The map is shown opened in FIG. 31. FIG. 31 shows using the GUI to display the map opened from FIG. 30, and further closing of the map window, as shown by the “hand” clicking on the window closing symbol.

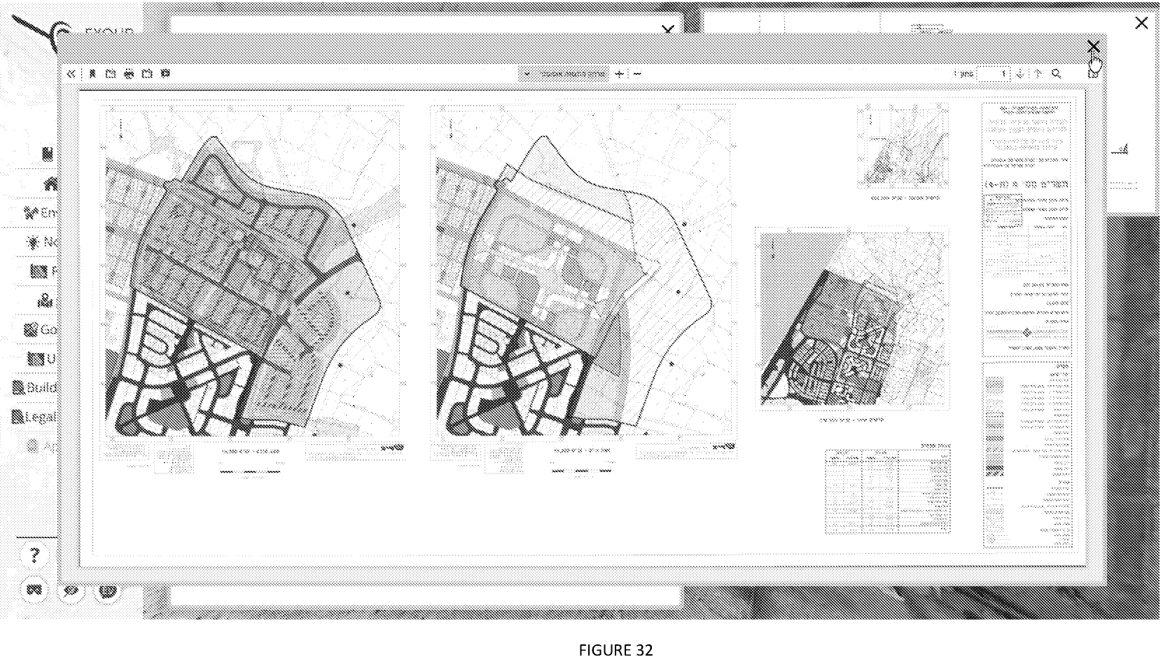

FIG. 32 shows using the GUI to scroll to the next page in the interactive professional opinion, following closing of the map window from FIG. 31, as shown by the “hand” clicking on right-hand scroll arrow in the document description.

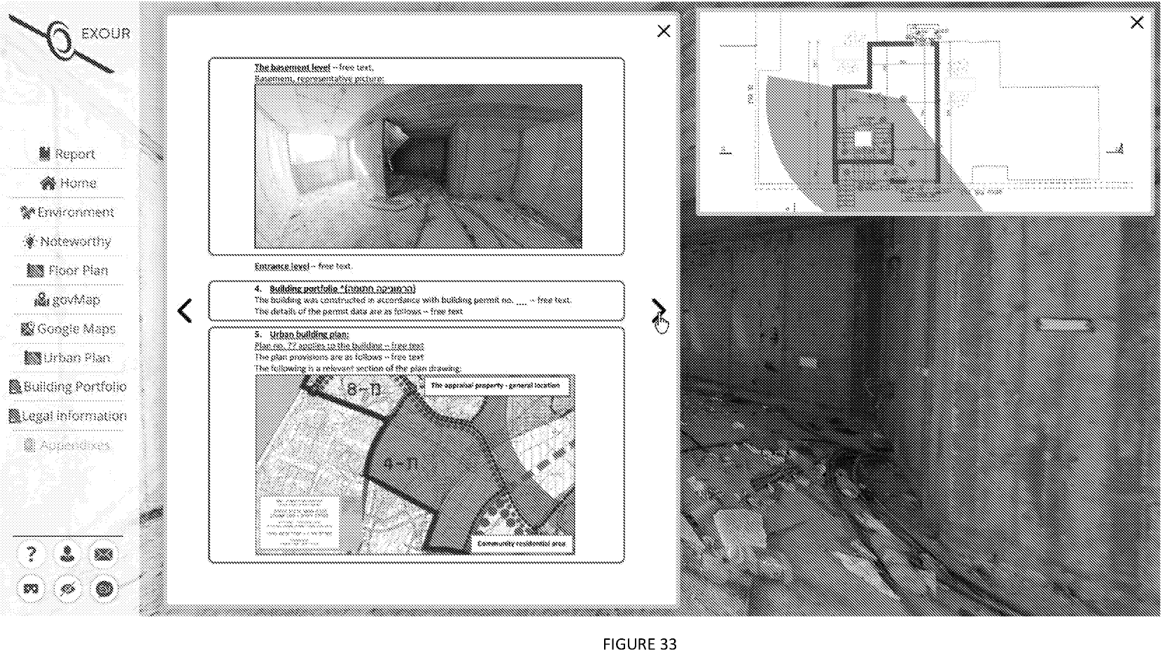

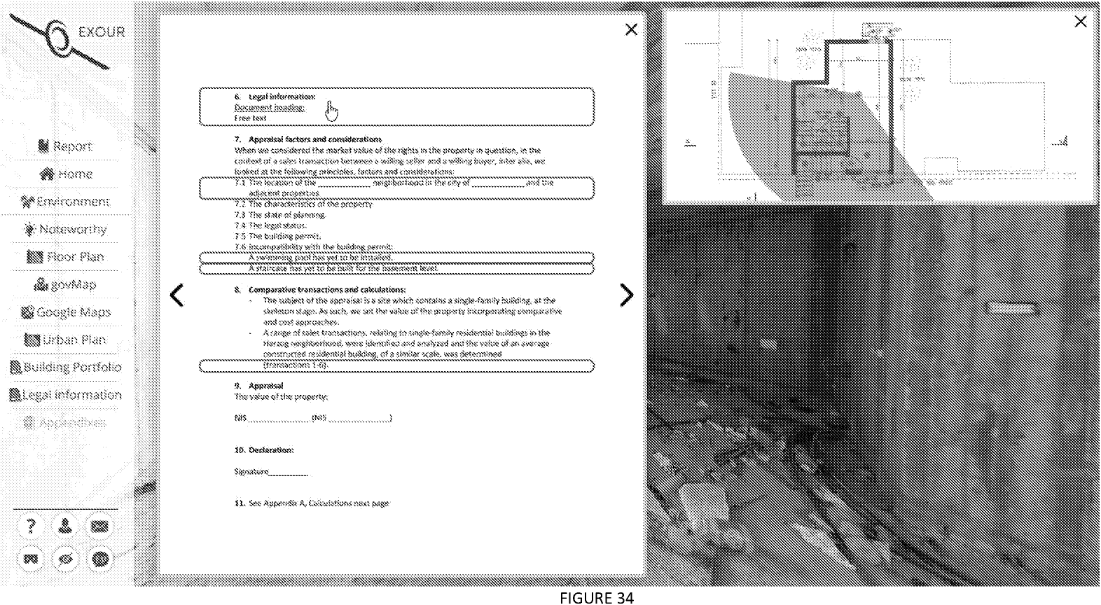

FIG. 33 shows using the GUI to open a document described in the professional opinion, as shown by the “hand” clicking on the button associated with the section titled Legal Information.

FIG. 34 shows using the GUI to display the Legal Information document opened from FIG. 33.

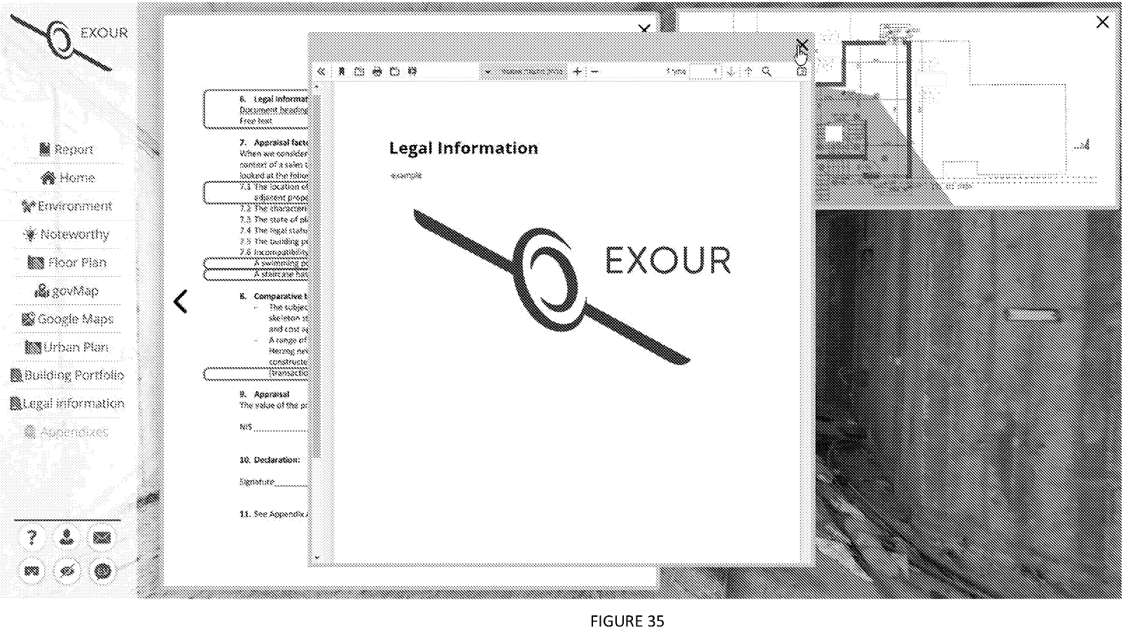

FIG. 35 shows using the GUI to click on a specific place in the professional opinion to refer the reader to a specific point in the virtual tour relating to the clause in the professional opinion, as shown by the “hand” clicking on the button associated with section 7.1. In this case this relates to a 360 degree bird’s eye view of the property area.

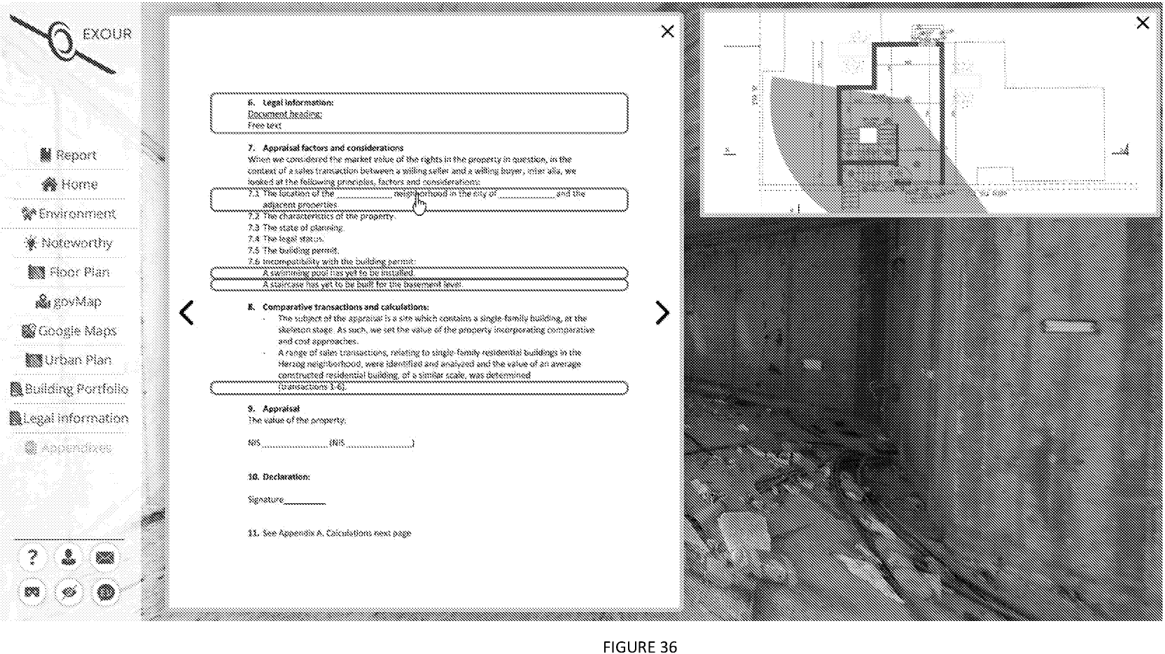

FIG. 36 shows using the GUI to display a 360 degree bird’s eye view of the surroundings of the property.

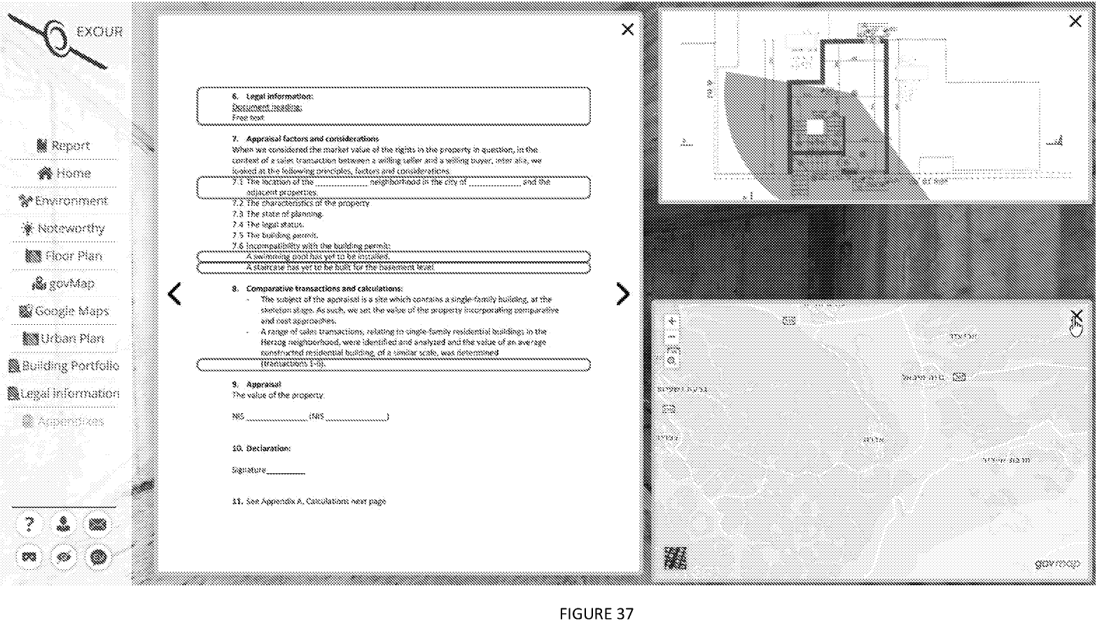

FIG. 37 shows using the GUI to reopen the professional opinion for the purpose of scrolling and clicking on a specific point in the professional opinion which refers the reader to a specific point in the virtual tour relating to the clause in the professional opinion, as shown by the “hand” clicking on the Interactive Report button.

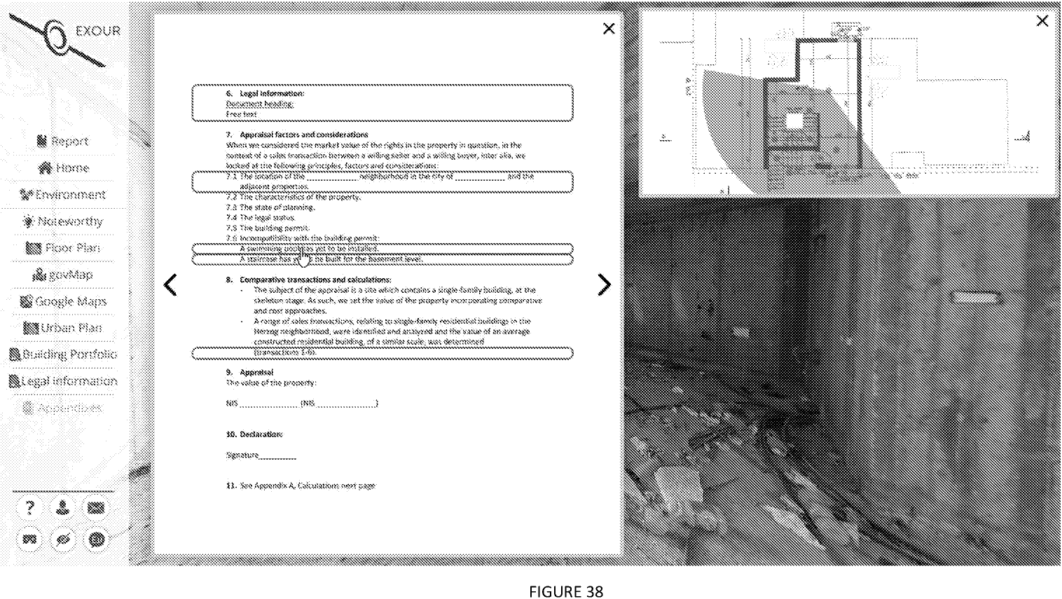

FIG. 38 shows using the GUI to access a specific point in the virtual tour connected to a selected button in the professional report. In this case this refers to a comment regarding the lack of construction of a swimming pool and a staircase on the basement level, as shown by the “hand” clicking on the button next to section 7.6 in the opinion.

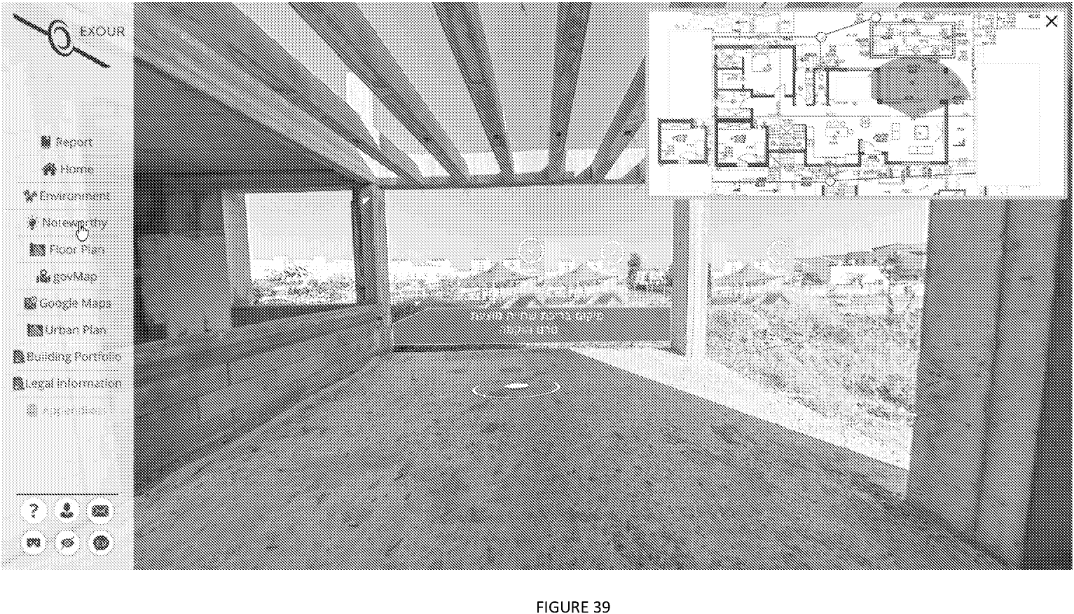

FIG. 39 shows using the GUI to access a more specific point in the virtual tour connected to the selected button in the professional report in FIG. 38. In this case this refers to a comment regarding the lack of construction of a staircase on the basement level, as shown by the “hand” clicking on the button next to the comment regarding the staircase in section 7.6 of the report.

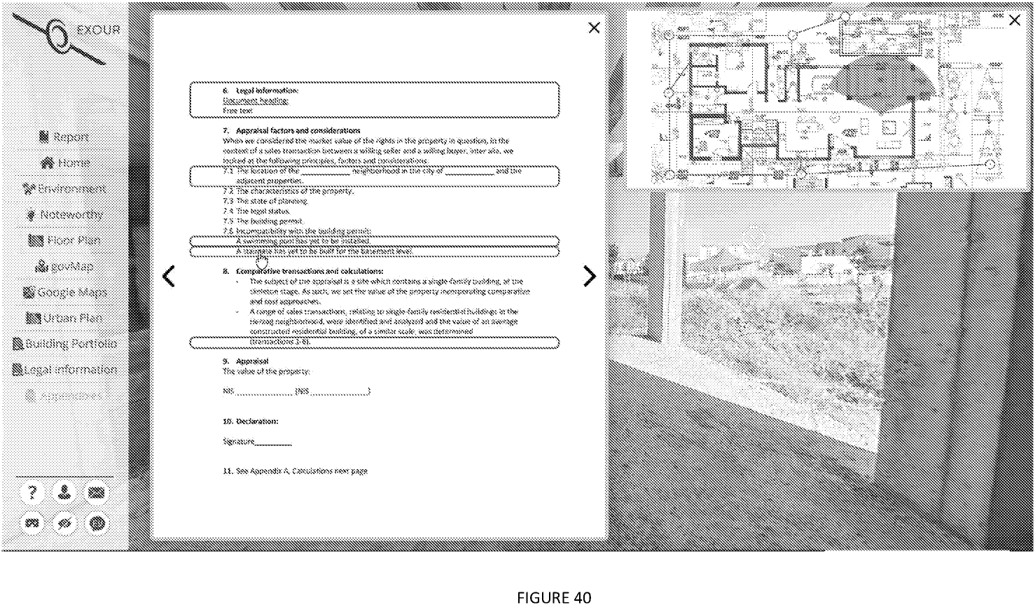

FIG. 40 shows using the GUI to display the basement area where the staircase is supposed to be constructed following clicking of the button from FIG. 39, and the outline of the shape of the stairs including its location in the basement. Also shown is the “hand” clicking on the Interactive Report button to return to the report.

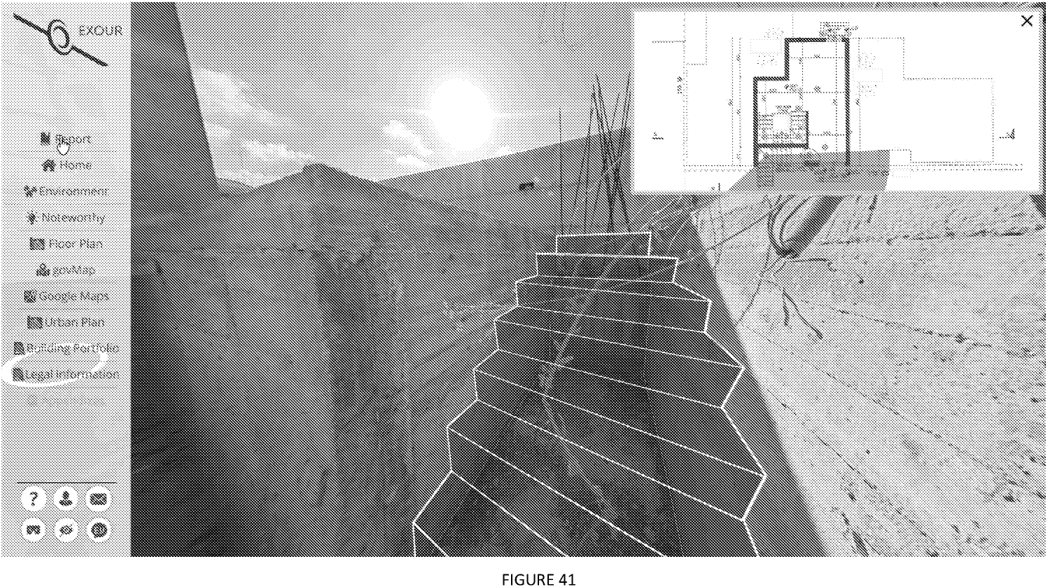

FIG. 41 shows using the GUI, following returning to the professional opinion (from FIG. 40), to scroll down the professional opinion and clicking on data in the professional opinion relating to a different property, as shown by the “hand” clicking on the button next to item 2 in the table.

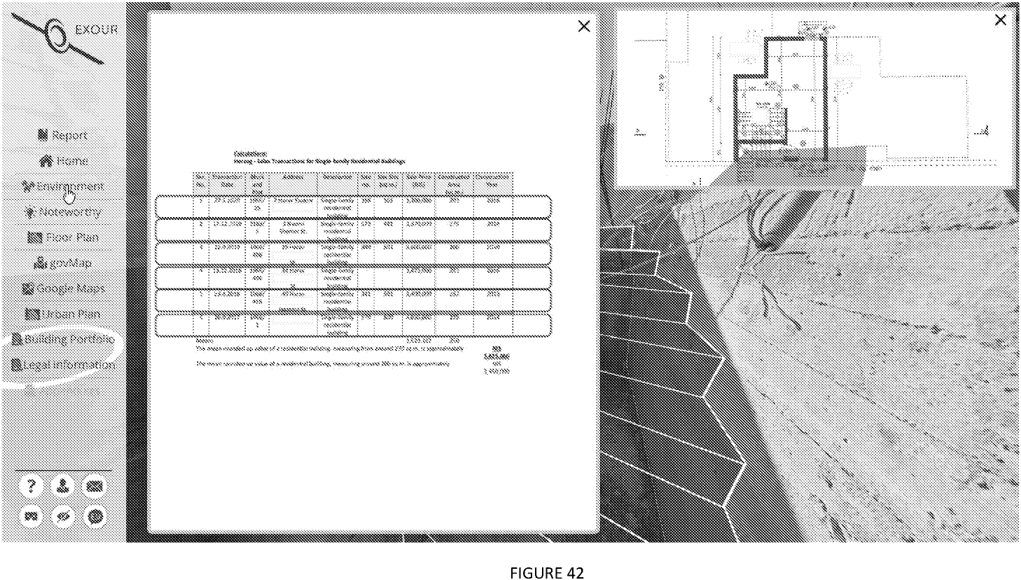

FIG. 42 shows using the GUI to display the specific point (location) in the virtual tour connected to the activated button in FIG. 41, as shown by the marker including property details appearing in the bird’s eye view of the surrounding area. In this case this refers to a different property. The “hand” is shown clicking the Interactive Report button in order to optionally see the property details in the marker and/or to access the professional opinion.

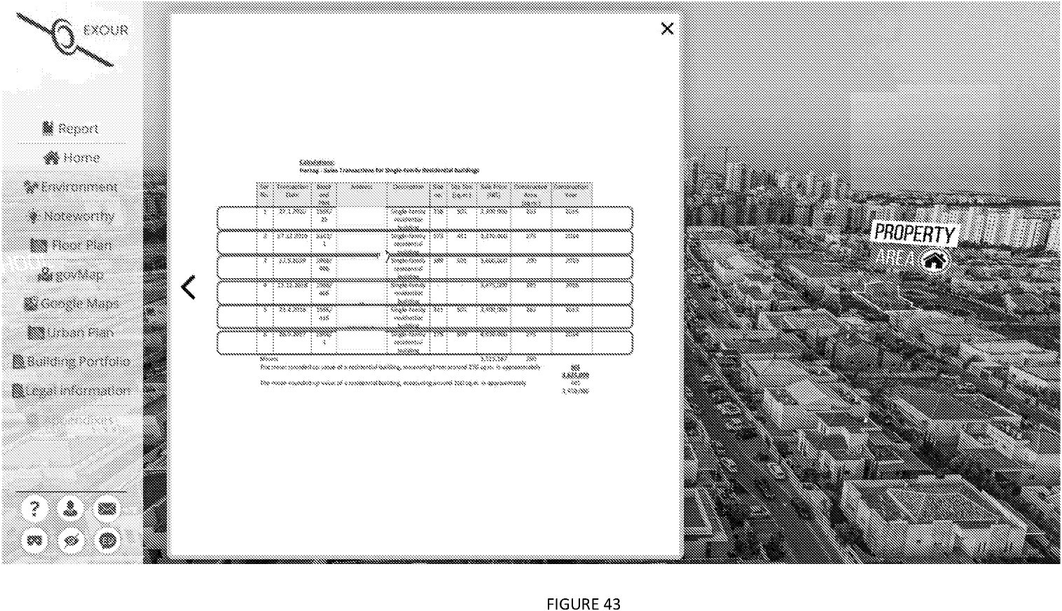

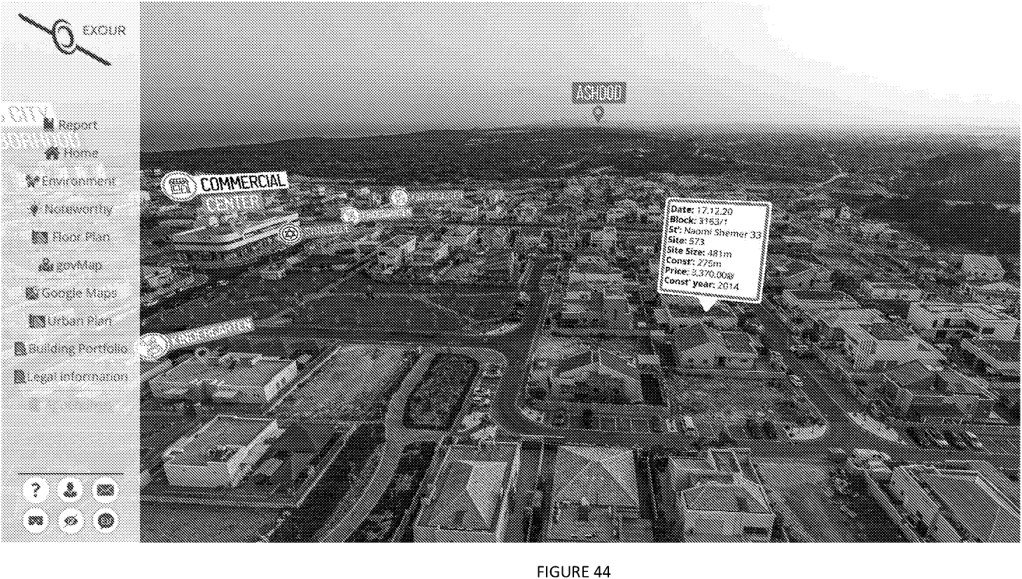

FIG. 43 shows using the GUI clicking a hide graphic markings button for the purpose of a clear view of the virtual tour.

Unless specifically stated otherwise, as apparent from the preceding discussions, it is appreciated that, throughout the specification, discussions utilizing terms such as “processing,” “computing,” “calculating,” “determining,” or the like, refer to the action and/or processes of a computer, computing system, or similar electronic computing device that manipulates and/or transforms data represented as physical, such as electronic, quantities within the computing system’s registers and/or memories into other data similarly represented as physical quantities within the computing system’s memories, registers or other such information storage, transmission or display devices.

Embodiments of the present invention may include apparatus for performing the operations herein. This apparatus may be specially constructed for the desired purposes, or it may comprise a general-purpose computer selectively activated or reconfigured by a computer program stored in the computer. Such a computer program may be stored in a computer readable storage medium, such as, but not limited to, any type of disk, including floppy disks, optical disks, magnetic-optical disks, read-only memories (ROMs), compact disc read-only memories (CD-ROMs), random access memories (RAMs), electrically programmable read-only memories (EPROMs), electrically erasable and programmable read only memories (EEPROMs), magnetic or optical cards, Flash memory, or any other type of media suitable for storing electronic instructions and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

1. A computer-implemented method of generating interactive site reports, the method comprising:
acquiring data associated with a specific site;
generating three-dimensional images of the site;
generating markings to enable a user to access detailed information regarding the site; and
displaying the information on a computing device.

2. A computer-implemented method of claim 1 further comprising acquiring said data in a professional report.

3. A computer-implemented method of claim 1 wherein said displaying is through a graphics unit interface (GUI) on said computing device.

4. A computer-implemented method of claim 1 wherein said data comprises two-dimensional images of said site.

5. A computer-implemented method of claim 1 wherein said data comprises three-dimensional images of said site.

6. A computer implemented method of claim 1 wherein said data comprises open expert data.

7. A computer-implemented method of claim 1 wherein said data comprises individual expert data.

8. A computer-implemented method of claim 1 further comprising providing detailed information to the user responsive to clicking on said markings.

9. An interactive site analysis report generation system comprising:
a graphic unit interface (GUI) for acquiring data associated with a specific site, for generating three-dimensional images of the site, and for displaying the information on a computing device; and
a site analyzer to generate markings to enable a user to access detailed information regarding the site on said GUI.

10. An interactive site analysis report generation system of claim 9 further comprising acquiring said data in a professional report.

11. An interactive site analysis report generation system of claim 9 wherein said data comprises two-dimensional images of said site.

12. An interactive site analysis report generation system of claim 9 wherein said data comprises three-dimensional images of said site.

13. An interactive site analysis report generation system of claim 9 wherein said data comprises open expert data.

14. An interactive site analysis report generation system of claim 9 wherein said data comprises individual expert data.

15. An interactive site analysis report generation system of claim 9 further comprising providing detailed information to the user responsive to clicking on said markings.
